(19) United States
(12) Patent Application Publication
(10) Pub. No.: US 2018/0023804 A1
(43) Pub. Date: Jan. 25, 2018

(54) WATER TREATMENT AND STEAM GENERATION SYSTEM FOR ENHANCED OIL RECOVERY AND A METHOD USING SAME

(71) Applicant: GREAT OCEAN LTD., Calgary (CA)

(72) Inventors: Henry Z. Qin, Calgary (CA); Wen Li Zhang, Calgary (CA)

(21) Appl. No.: 15/215,714

(22) Filed: Jul. 21, 2016

(51) Int. Cl. F22B 1/00; C02F 1/24; F22B 33/18; F22B 1/18; F22B 29/06; C02F 1/40; B01D 17/02

(52) U.S. Cl. CPC F22B 1/006; C02F 1/40; C02F 1/24; B01D 17/0214; F22B 1/18; F22B 29/06; F22B 33/18; C02F 2103/10

(57) ABSTRACT

A system and method of generating steam from a emulsion stream produced from a reservoir via thermal recovery. The system includes a heat exchanger for adjusting the emulsion to a first temperature; at least one separation device for separating water from the emulsion at the first temperature to obtain produced water; and a high pressure evaporator for receiving the produced water at the first temperature and generating steam using the produced water. Also, an evaporator includes a vapor drum; a heating element in fluid communication with the vapor drum, said heating element receiving the water stream; a heating source for vaporizing the water stream for generating steam; and a bubble generator for generating bubbles and injecting generated bubbles into the heating element.

### FIELD OF THE DISCLOSURE

The present invention relates generally to a water treatment and steam generation system, and in particular, to a water treatment and steam generation system for enhanced oil recovery, and a method using same.

### BACKGROUND

Hydrocarbon resources, such as oil sand or bituminous sand deposits, are found predominantly in the Middle East, Venezuela, and Western Canada. The Canadian bitumen deposits, being the largest in the world, are estimated to contain between 1.6 and 2.5 trillion barrels of oil.

Bitumen is heavy, black oil, which cannot be readily pumped from the ground due to its high viscosity. As is well known in the art, bituminous sands can be extracted from subterranean reservoirs by lowering the viscosity of the hydrocarbons in-situ, mobilizing the hydrocarbons such that they can be recovered from the reservoir. Many thermal-recovery processes, such as Steam Assisted Gravity Drainage (SAGD), have been developed to reduce the viscosity by applying heat, chemical solvents or a combination thereof, and mobilize the viscosity-reduced hydrocarbons for better recovery. Such recovery processes typically involve the use of one or more “injection” and “production” wells drilled into the reservoir, whereby a heated fluid (e.g. steam) can be injected into the reservoir through the injection wells and hydrocarbons can be retrieved from the reservoir through the productions wells.

The fluid produced from the reservoir is usually a mixture of oil and water, so-called emulsion. The emulsion is first processed for oil/water separation in a central processing facility (CPF). Bitumen separated from the emulsion is transported to offset facilities for further processing. Water separated from the emulsion is de-oiled, treated and recycled within the CPF for steam generation and reinjection. Commercial SAGD plants in Alberta, Canada typically recycle more than 90% of the water from emulsion for steam generation.

Traditionally, in order for the water retrieved during the separation/de-oiling processes to be reused, recycled and/or reinjected, the retrieved water must go through the following two-steps:

a) water softening, via a standard atmospheric pressure evaporator or water softener (using lime softening and ion exchange), each method requiring the energy-intensive cooling of the de-oiled water, and

b) steam generation, via a drum boiler or a once-through steam generator (OTSG), where the cooled water is heated up again to generate the steam.

Typically, existing evaporators are forced circulation mechanical vapor compression evaporators, comprising a vapor drum with vertical or horizontal heating tubes and auxiliary equipment such as a mechanical vapor compressor, recirculation pumps, tanks and exchangers.

For example and as will be described in more detail later, two water treatment technologies are generally known and available for commercial SAGD projects. One process uses lime softening and ion exchange for treating produced water, followed by a once-through steam generator (OTSG) boiler. The other process uses evaporation for treating produced water, followed by a drum boiler. Both processes use fired boiler to generate high pressure steam and both require water treatment prior to steam generation.

These known processes are costly, time-intensive, and energy inefficient, requiring significant operational care, and resulting in significant power consumption and consequently high greenhouse emissions.

For example, the above-described processes are far from being energy efficient, due to cyclic temperature changes and/or phase changes along the water path, which is largely because of the contradicting process requirements before and after water softening, including cooling the hot produced water to prevent flashing in the atmospheric tanks or damaging the ion exchanges, and later heating softened water up to reserve boiler fuel consumption.

It is therefore an object to provide a novel water treatment system with lower cost and less power consumption for treating water in enhanced oil recovery, and a method using same.

### SUMMARY

According to one aspect of this disclosure, there is provided a method of generating steam from an emulsion stream produced from a reservoir via thermal recovery. The emulsion stream is a mixture of oil and water. The method comprises: adjusting the emulsion to a first temperature; obtaining produced water from the emulsion at the first temperature; and generating steam from the produced water at the first temperature.

In some embodiments, said first temperature is above 100° C.

In some embodiments, said first temperature is between about 100° C. and about 250° C.

In some embodiments, said first temperature is between about 100° C. and about 200° C.

In some embodiments, said first temperature is between about 140° C. and about 150° C.

In some embodiments, said obtaining produced water from the emulsion at the first temperature comprises: separating water from the emulsion at the first temperature; and removing residual oil from the separated water to obtain the produced water.

In some embodiments, said removing residual oil from the separated water to obtain the produced water comprises: removing residual oil from the separated water by using at least two pressurized, high-temperature, induced gas flotation units (IGF's) coupled in series, to obtain the produced water.

In some embodiments, said generating steam from the produced water at the first temperature comprises: generating steam from the produced water at the first temperature by using a high pressure evaporator operating at a first pressure.

In some embodiments, said removing residual oil from the separated water to obtain the produced water further comprises: using at least one pump to adjust the pressure of the produced water to the first pressure, and to feed the produced water to the high pressure evaporator.

In some embodiments, said generating steam from the produced water at the first temperature by using the high pressure evaporator operating at the first pressure further comprises: using solar power to directly heat up a heating medium of the high pressure evaporator; feeding the produced water into the high pressure evaporator at the first temperature; and generating steam from the produced water using the heated heating medium.

In some embodiments, said generating steam from the produced water at the first temperature by using the high pressure evaporator operating at the first pressure further comprises: using a secondary heater as a secondary heating source for compensating for the solar power for heating up the heating medium of the high pressure evaporator.

In some embodiments, said generating steam from the produced water at the first temperature by using the high pressure evaporator operating at the first pressure further comprises: automatically shutting down the secondary heater if the solar power is sufficient for heating up the heating medium; and automatically turning on the secondary heater and adjusting the heating power thereof, if the solar power is insufficient for heating up the heating medium.

In some embodiments, the secondary heater is a fired heater.

In some embodiments, said generating steam from the produced water at the first temperature by using the high pressure evaporator operating at the first pressure further comprises: separating impurities from the produced water, the separated impurities forming a blowdown stream; and discharging the blowdown stream.

In some embodiments, said discharging the blowdown stream comprises: cooling the blowdown stream; and discharging the cooled blowdown stream.

In some embodiments, said generating steam from the produced water at the first temperature by using the high pressure evaporator operating at the first pressure further comprises: injecting bubbles into the high pressure evaporator for fouling mitigation and heat transfer improvement.

According to another aspect of this disclosure, there is provided a system for generating steam from a emulsion stream produced from a reservoir via thermal recovery. The emulsion stream is a mixture of oil and water. The system comprises: a heat exchanger for adjusting the emulsion to a first temperature; at least one separation device for separating water from the emulsion at the first temperature to obtain produced water; and a high pressure evaporator for receiving the produced water at the first temperature and generating steam using the produced water.

In some embodiments, the high pressure evaporator comprises: a vapor drum; a heating element in fluid communication with the vapor drum, said heating element receiving the produced water at the first temperature; a heating source for vaporizing the produced water for generating steam; and a bubble generating device for generating bubbles and injecting generated bubbles into the heating element.

According to another aspect of this disclosure, there is provided an evaporator receiving a water stream and generating steam from the water stream. The evaporator comprises: a vapor drum; a heating element in fluid communication with the vapor drum, said heating element receiving the water stream; a heating source for vaporizing the water stream for generating steam; and a bubble generator for generating bubbles and injecting generated bubbles into the heating element.

In some embodiments, the bubble generator uses pipeline gas for generating bubbles.

In some embodiments, the evaporator further comprises: a condenser for receiving a portion of generated steam and condensing received steam to water. The bubble generator receives the condensed water discharged from the condenser and mixes the pipeline gas with the received water for generating a water stream with gas bubbles for feeding into the heating element.

In some embodiments, the bubble generator is a sparger.

In some embodiments, the bubble generator is a bubble pump.

In some embodiments, the bubble generator is an educator/pump combination.

In some embodiments, the heating element comprises one or more vertical heating tubes for receiving water injected therein, and a heating channel for receiving heating medium heated by the heating source for vaporizing the water in the one or more heating tubes.

In some embodiments, the evaporator further comprises a steam/liquid interface separating steam thereabove and liquid therebelow. The steam/liquid interface is maintained at a level such that the one or more heating tubes are entirely submerged in liquid.

In some embodiments, the evaporator is configured to a plurality of modules, the plurality of modules being interconnectable for forming a module block.

In some embodiments, each of the plurality of modules comprises a frame of a standard shipping container in accordance with ISO standard 668.

In some embodiments, the plurality of modules comprise at least one vapor drum module, at least one heating element module and at least one piping module.

In some embodiments, at least one heating element module is configured at a corner of a module block.

### BRIEF DESCRIPTION OF THE DRAWINGS

FIG. 1 is a schematic diagram of a prior-art, three-stage, WLS-OTSG water treatment process for enhanced oil recovery;

FIG. 2 shows the devices and detailed process of the phase separation stage of the WLS-OTSG process of FIG. 1;

FIG. 3 shows the devices and detailed process of the water softening stage of the WLS-OTSG process of FIG. 1;

FIG. 4 shows the devices and detailed process of the steam generation stage of the WLS-OTSG process of FIG. 1;

FIG. 5 is a schematic diagram of another prior-art, three-stage, evaporator-drum boiler water treatment process for enhanced oil recovery;

FIG. 6 shows the devices and detailed process of the phase separation stage of the evaporator-drum boiler process of FIG. 5;

FIG. 7 shows the devices and detailed process of the water softening stage of the evaporator-drum boiler process of FIG. 5;

FIG. 8 shows the devices and detailed process of the steam generation stage of the evaporator-drum boiler process of FIG. 5;

FIG. 9 is a schematic diagram of a two-stage water treatment process for enhanced oil recovery, according to one embodiment of this disclosure;

FIG. 10 shows the devices and detailed process of the phase separation stage of the process of FIG. 9;

FIG. 11 shows the devices and detailed process of the steam generation stage of the process of FIG. 9;

FIG. 12 is a schematic diagram of a prior-art, rising film long tube vertical evaporator;

FIG. 13 is a schematic diagram of a prior-art, revised rising film long tube vertical evaporator;

FIG. 14A is a schematic diagram of a high-pressure, gas induced circulation (GIC) evaporator having a sparger/pump assembly, according to one embodiment of this disclosure;

FIG. 14B is a schematic diagram of a portion of the high-pressure, GIC evaporator of FIG. 14A, showing the circulation of bubble-mixed liquid between the heating element and the vapor drum;

FIG. 15A is a schematic diagram of high-pressure, GIC evaporator having a bubble pump and using condensed steam for bubble generation, according to an alternative embodiment of this disclosure;

FIG. 15B is a schematic diagram of high-pressure, GIC evaporator using an external water source for bubble generation, according to yet another embodiment of this disclosure;

FIG. 15C is a schematic diagram of high-pressure, GIC evaporator and using the feed water for bubble generation, according to still another embodiment of this disclosure;

FIG. 15D is a schematic diagram of high-pressure, GIC evaporator comprising one vapor drum and two heating elements, according to another embodiment of this disclosure;

FIG. 15E is a schematic diagram of high-pressure, GIC evaporator comprising two vapor drum and four heating elements, according to another embodiment of this disclosure;

FIG. 16 is a schematic diagram showing a system and process of using a GIC evaporator to treat OTSG blowdown, according to one embodiment of this disclosure;

FIG. 17 is a schematic diagram showing a system and process of using a GIC evaporator to treat OTSG blowdown, according to an alternative embodiment of this disclosure;

FIG. 18 is a schematic diagram showing a system and process of using a GIC evaporator to treat fracking produced water, according to an alternative embodiment of this disclosure;

FIG. 19A is a perspective view of a portion of a module frame of a modularized GIC evaporator in a vertical, operation orientation, according to an alternative embodiment of this disclosure;

FIG. 19B is an enlarged perspective view of the module frame of FIG. 19A;

FIG. 19C is a perspective view of the portion of the module frame of FIG. 19A in a horizontal, transportation orientation;

FIG. 19D is an enlarged perspective view of the module frame of FIG. 19C;

FIG. 20A is a schematic diagram showing an example of a modularized GIC evaporator block for configuring a GIC evaporator; and

FIG. 20B is a schematic diagram showing the modularized GIC evaporator block of FIG. 20A with one module being removed from the block.

### DETAILED DESCRIPTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise;

The terms “comprising”, and “including”, as used herein, will be understood to mean that the list following is non-exhaustive and may or may not include any other additional suitable items, for example one or more further feature(s), component(s) and/or ingredient(s) as appropriate.

The term “Steam Assisted Gravity Drainage” and its abbreviation of “SAGD”, as used herein, will be understood to mean all thermal in-situ production and processing oil methods including Cyclic Steam Stimulation (CSS), and/or other enhanced thermal exploration, production and processing methods with or without solvent(s) and non-condensable gases co-injection, in the scope of this disclosure.

The term “oil sands” refers to large subterranean land formations composed of reservoir rock, water and heavy oil and/or bitumen.

The term “bitumen”, as used herein, will be interchangeable with “heavy oil”.

The term “fouling resistant”, as use herein, will be understood to mean resistance to all of salting, scaling and fouling.

The term “warm lime softener” and its abbreviation of “WLS”, as used herein, will be understood to mean all the lime softening process, including hot softener which has an abbreviation of “HLS”.

The term “high pressure” and its abbreviation of “HP” as used herein, will be understood to mean the pressure of 300 psig (2,069 kPag) and above. The term “medium pressure” and its abbreviation of “MP” will be understood to mean the pressure between 100 psig (690 kPag) and 300 psig (2,069 kPag). The term “low pressure” and its abbreviation of “LP” will be understood to mean the pressure between 15 psig (103 kPag) and 100 psig (690 kPag). The term “atmospheric pressure” and its abbreviation of “AP” will be understood to mean the pressure between vacuum and 15 psig (103 kPag).

In the following, there is disclosed a system and a method for treating produced water in enhanced oil recovery, such as heavy oil or bitumen extraction using SAGD and/or other thermal in-situ technologies, including the CSS. Because water can comprise up to 90% of the oil/water mixture recovered from the reservoir, and the combination of water treatment and steam generation usually accounts for about 60% of the capital cost in a commercial greenfield project, the water treatment system disclosed herein can provide significant economic and environmental benefits to all stakeholders.

The system disclosed herein focuses on both the cost and energy efficiency to make thermal in-situ oil projects less capital intense, more energy efficient and more renewable energy friendly. The system is cost efficient as the disclosed GIC evaporator is easier to construct, and tolerates feed water with much lower grade than ASME boilers do for the applications of high pressure steam generation, leading to a leaner method.

The system disclosed herein is energy efficient as it streamlined both temperature and pressure, and eliminated cyclic temperature changes and/or phase changes along the water path as observed in prior arts. The system is a high temperature, pressurized system. For example, the operation condition at the system inlet may be about 100 psig at about 140° C. (284° F.), and the operation condition at the system outlet may be up to about 1600 psig at about 319° C. (606° F.). Thus, the system enables water treatment and steam generation in one step directly from the de-oiled produced water with mitigated scaling and/or fouling, by using a high pressure evaporator, or more preferably using a high-pressure fouling-resistant evaporator. The disclosed system is also renewable energy integratable, using solar and other forms of renewable energy for high pressure steam generation.

As is known in the art, silica precipitation is undesirable and harmful to water treatment devices as solid silica can lower the heat transfer efficiency of heat exchangers, and can cause heating tubes of the boiler failure. Traditionally, large amount of caustic has to be added to water to increase the pH value of the water for preventing silica precipitation, which, however, increases scaling.

The process disclosed herein maintains pressurized, high temperature water throughout the entire water path from the oil/water separation to the evaporator. The maintained high temperature increases the solubility of silica at a lower pH value, mitigating scaling and reducing caustic addition. Consequently, the system disclosed herein eliminates the need of water softening, and simplifies the de-oiling process.

While the disclosed water treatment system streamlines temperature and pressure from oil/water separation and de-oiling to steam generation for higher energy efficiency, it also removes the need of any produced-water cooler between the treater and the skim tank in prior art, eliminating the issues of fouling that may incur high cost to SAGD producers for maintenance and production loss.

The system and method disclosed herein replace the traditional water softening and steam generation steps with a single step of steam generation using a high-pressure evaporator. The disclosed high pressure evaporator is simple, low cost and with no or few rotating components, and is capable of operating at high temperatures and pressures, e.g., up to ANSI Class 900 rating. In comparison, the forced circulation mechanical vapor-compression type evaporator commonly used for existing SAGD water treatment systems is not suitable for the disclosed system because of the temperature and pressure limits for the rotating components thereof.

In some embodiments, the high pressure evaporator disclosed herein is a high-pressure, rising-film long-tube vertical evaporator functioning at high pressure and temperature, and generating steam directly from the de-oiled produced water. The high pressure evaporator disclosed herein also reduces the risks of salting, scaling and/or fouling. The disclosed high pressure evaporator is suitable for steam generation in the central processing facility (CPF) of a SAGD plant, or other thermal in-situ plants.

In some embodiments, the evaporator disclosed herein uses renewable energy such as solar or wind power for vaporizing the evaporator feed water. For example, in one embodiment, the evaporator disclosed herein integrates the heat transfer fluid from a solar parabolic trough system or other concentrating collectors with the GIC evaporator and uses solar power to directly heat and vaporize the feed water, avoiding the traditional power conversion from solar power to electricity and then heat.

In some other embodiments, a secondary heating source, e.g., a fired heater, is also used to supplement intermittent solar or wind power source. The fired heater is automatically shut down when the renewable energy is sufficient for water vaporization, and is automatically turned on when the renewable energy is insufficient.

In some other embodiments, evaporator blowdown, which contains impurities and some water, is cooled and further concentrated by flashing it to a low pressure flash drum. The flashed low pressure vapor is condensed, cooled and recombined with the low pressure blowdown prior to dewatering and/or disposal.

In some embodiments, the evaporator disclosed herein is a gas induced circulation evaporator that uses gas bubble to enable sludge circulation between the heating tubes and the sludge bottom, reducing the tendency of fouling.

In some embodiments, the disclosed evaporator is based on a revised rising film long tube vertical (RFLTV) evaporator, and modifies it for use without salting, scaling and/or fouling. As is known in the art, RFLTV evaporators are normally used in food industry for milk processing. While inexpensive, RFLTV evaporators are known for poor heat transfer efficiency, and are generally not suitable for salting and severely scaling application. The disclosed evaporator modifies the structure and operation of RFLTV evaporators to solve the problems, resulting in an evaporator with fouling-resistance and improved heat transfer efficiency.

In some embodiments, the disclosed evaporator is modified from the RFLTV evaporators by increasing the liquid level in the vapor drum to entirely submerge the heating tubes of the heating element. High pressure gas is injected at a controlled rate to the heating tube inlet through a bubble generator, such as a sparger/pump assembly, to generate fine size gas bubbles flowing uniformly upwards to the top of the vertical long heating tubes. The bubbles increase the static head difference between the vapor drum and the heating tubes, forcing the concentrate sludge to circulate and therefore to mitigate salting.

The submerged heating tubes can also avoid boiling and flashing of the feed stream, thereby reducing the tendency of scaling, fouling and slugging in the tubes. The controlled bubbles help to maintain a higher liquid velocity along the entire tubes for improved and predictable heat transfer efficiency, and keep the solids in suspension.

In some embodiments, the evaporator disclosed herein is a modularized assembly allowing the heating element to be easily isolated, removed and transported offsite for cleaning, maintenance and repair. In particular, the evaporator disclosed herein comprises a plurality of container modules, allowing one or more heating element modules to be removed while other modules are still in operation. The removed heating element modules may be transported offsite for cleaning, maintenance and/or repair in a prompt and cost effective manner.

In some embodiments, the container modules have a size and weight similar to those of standard containers, and thus can be easily transported and relocated among various thermal in-situ and shale oil/gas production well sites.

The evaporator disclosed herein may be used in various applications in addition to the above described water treatment system. In some embodiments, the disclosed evaporator may be used to concentrate the blowdown of Once-Through Steam Generators (OTSGs). Alternatively, the disclosed evaporator can be used for making high grade boiler feed water for drum boiler in a SAGD plant, or treat the fracking produced water from shale oil or a shale gas production.

The fracking process needs up to one million gallons (3,780 m³) of fresh water per well. However, up to 60% of the water injected into a well during the fracking process will eventually be discharged out of the well as flow-back wastewater. Considering the hundreds or thousands of wells being or to be drilled, the disclosed evaporator can provide significant economic benefit by treating and reusing the flow-back wastewater.

For purposes of illustration and comparison, two prior-art water treatment processes are first described.

FIG. 1 is a schematic diagram of a prior-art, three-stage water treatment process 100 for enhanced oil recovery such as SAGD. The process 100 uses warm lime softener (WLS) to treat water in the emulsion 104 produced from a reservoir 102 through one or more thermal wells, and a once-through steam generators (OTSG) to generate high pressure injection steam. This process is denoted as a WLS-OTSG process.

In this embodiment, the emulsion 104 is a high-temperature (typically between about 170° C. to about 180° C.) oil and water mixture produced from the reservoir 102 by thermal production, and usually contains some gas, solids and hardness/silica that may cause fouling in water treatment devices. The process 100 separates water from the emulsion 104, removes impurities (e.g., residual oil, gas, solids and hardness), and generates high pressure steam.

As shown, in a first, phase separation stage 106, the emulsion 104 produced from the reservoir 102 is processed by oil/water separation 112 for separating oil, water and solids. The oil separated therefrom is further processed and the detail thereof is omitted herein.

Water 114 separated from the emulsion 104 usually still contains a small amount of residual oil, and is further processed by de-oiling 116 to remove residual oil therein, obtaining de-oiled water 118 (also denoted as produced water).

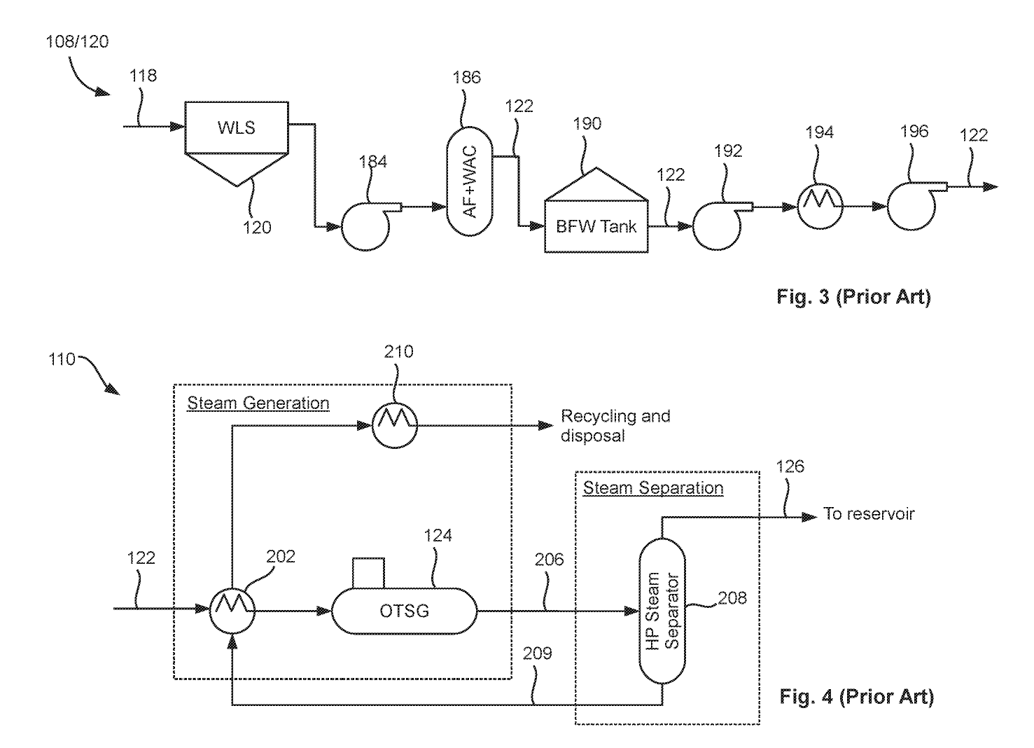

At a second, water softening stage 108, the produced water 118 is fed into a water softening process containing a lime softener 120 and weak acid cations (WACs) or strong acid cations (SACs) 186 (see FIG. 3) for removing silica and hardness therein, outputting softened water 122.

At a third, steam generation stage 110, the softened water 122 is fed into an OSTG boiler 124 for generating high pressure (HP) steam 126, which may be injected into the reservoir 102 for oil production.

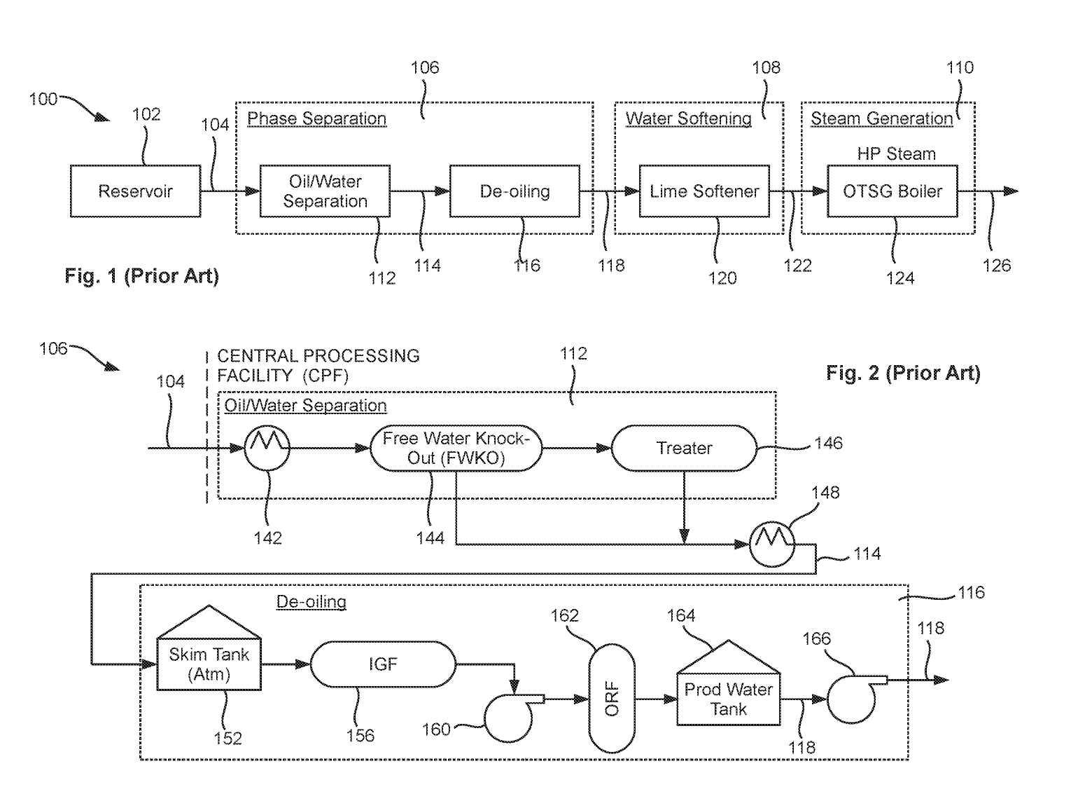

FIG. 2 shows the devices and detailed process of the phase separation stage 106 of the WLS-OTSG process 100, which are usually located in a CPF. As the emulsion 104 is a high-temperature oil and water mixture, it is first cooled down by an inlet cooler 142 (via, e.g., heat exchanging) to around 140° C. to 150° C., combined with dilute, and is then fed into a three-phase separator 144 such as a free water knock-out (FWKO) unit, which separates the majority of water from the oil and water mixture 104 using gravity. The oil separated by the FWKO 144, still containing some water, is fed into a treater 146 for desalting and dewatering, generating an oil product with impurity of less than 0.5% basic sediment and water (BS&W).

The water discharged from the FWKO 144 and the treater 146 is at a temperature around 140° C. to 150° C., but is further cooled by a produced-water cooler 148 to around 80° C. to 90° C. The cooled water 114 is then processed for de-oiling 116.

In this example, the cooled water 114 passes through a skim tank 152, an induced gas flotation (IGF) unit 156 and an oil removal filter (ORF) 162 for removing oil and fine solids therein. Pumps, e.g., transfer pump 160, may be used for transferring water between de-oiling units 152, 156 and 162. Each of the de-oiling units 152, 156 and 162 can remove about 90% oil from its inlet water. The produced water 118 discharged from the ORF 162 is stored in a produced water tank 164, and may be pumped by a transfer pump 166 from the produced water tank 164 to unit(s) in the water softening stage 108 for further processing.

FIG. 3 shows the devices and detailed process of the water softening stage 108 of the WLS-OTSG process 100. As shown, the produced water 118 discharged from the produced water tank 164 (FIG. 2) is processed using a warm lime softener (WLS) 120 and then a weak acid cation (WAC) ion exchange unit 186 for removing silica and hardness, respectively. After-filter (AF) may also be used for lowering the water turbidity. Pump 184 may be used for transferring water from WLS 120 to WAC ion exchange unit 186. The treated water 122 (also denoted as boiler feed water) discharged from the WAC ion exchange unit 186 is stored in a boiler feed water (BFW) tank 190, and may be re-heated by one or more cross-exchangers or heat exchangers 194 to a higher temperature before entering the steam generation stage 110 for steam generation. A low-pressure (LP) pump 192 is used to pump the boiler feed water 122 through the heat exchangers 194, which heats the feed water 122 using low grade heat, and then feeds the heated water 122 into the devices of the steam generation stage 110 via a high-pressure (HP) pump 196.

FIG. 4 shows the devices and detailed process of the steam generation stage 110 of the WLS-OTSG process 100. In this example, progressive heating is used, and, as shown, the boiler feed water 122 is first pre-heated, by a heat exchanger 202 using high grade heat, to around 180° C. to 190° C. The heated water 122 is then fed into an OTSG 124 for generating steam 206. The OTSG 124 can produce about 80% wet steam and about 20% blowdown based on treatment of a typical produced water with previously-described lime softener process 108, and must be followed by equipment to further separate blowdown for dry steam. In the example of FIG. 4, the wet steam 206 is fed into a high pressure steam separator 208, which generates high-temperature, high-pressure (HP) steam 126 for injecting into reservoir 102 or oil wells. Steam condensate 209 (typically at about 300° C. and usually containing some impurities) from the HP steam separator 208 is fed back to the heat exchanger 202, transferring heat to the boiler feed water 122. After heat exchange, the temperature reduced condensate 209 is fed to a blowdown cooler 210 to cool down for recycling and disposal.

While FIG. 4 shows a single-stage steam separator 208, multi-stage steam separation may be required when an improved water recycle rate is needed, and/or when low pressure steam is needed for a hot lime softener.

The above prior-art system 100 has several drawbacks. For example, oil contamination to the WLS 120 and the WAC ion exchange unit 186 can be costly because of the mass cleaning thereof, loss of production and/or equipment damage. Therefore, de-oiling 116 in the phase separation stage 106 is designed as a three-step process involving three units, i.e., a skim tank 152, an IGF 156 and an ORF 162, to provide necessary redundancy for safeguarding the WLS 120 and the WAC ion exchange unit 186 from oil contamination. Such multi-step de-oiling 116 gives rise to high cost in equipment and operation.

Another drawback in the phase separation stage 106 is the low energy efficiency, as the produced water has to be cooled down in the produced water cooler 148 from around 140° C. to 150° C. to around 80° C. to 90° C., and later heated to around 180° C. to 190° C. after water softening 108, wasting energy in this cooling-down/heating up cycle.

Further, the produced water cooler 148 is required in the above prior-art system 100 to prevent hot water discharged from FWKO 144 and the treater 146 from flashing into the skim tank 152 (FIG. 2) or melting the WAC ion exchange device 186 (FIG. 3). However, the produced water cooler 148 in the system 100 has strong tendency of fouling, and a good fouling prevention solution is yet to find.

The above-described water softening process 108 had been dominant in Alberta, Canada until a directive became effective to optimize water recycle efficiency and make up water sources. Depending on the produced water chemistry, this process may not be able to meet the required recycle unless a backend evaporator, another OTSG, or equivalent is also utilized.

The above-described water softening process 108 also requires a large number of equipment, resulting in high capital cost, and requires large environmental footprint. The water softening process 108 causes substantial energy and greenhouse gas emission due to frequent water transfers, including recycle, backwash, regeneration and rinse. The process 108 requires a substantial amount of chemicals, and skilled operators with a high level of operational attention.

As described above, in the event of oil channeling in the de-oiling 116, the produced water 118 fed into the water softening process 108 comprises excessive oil, causing a high risk of contaminating WLS 120, WAC ion exchange unit 186 and the OTSG 124.

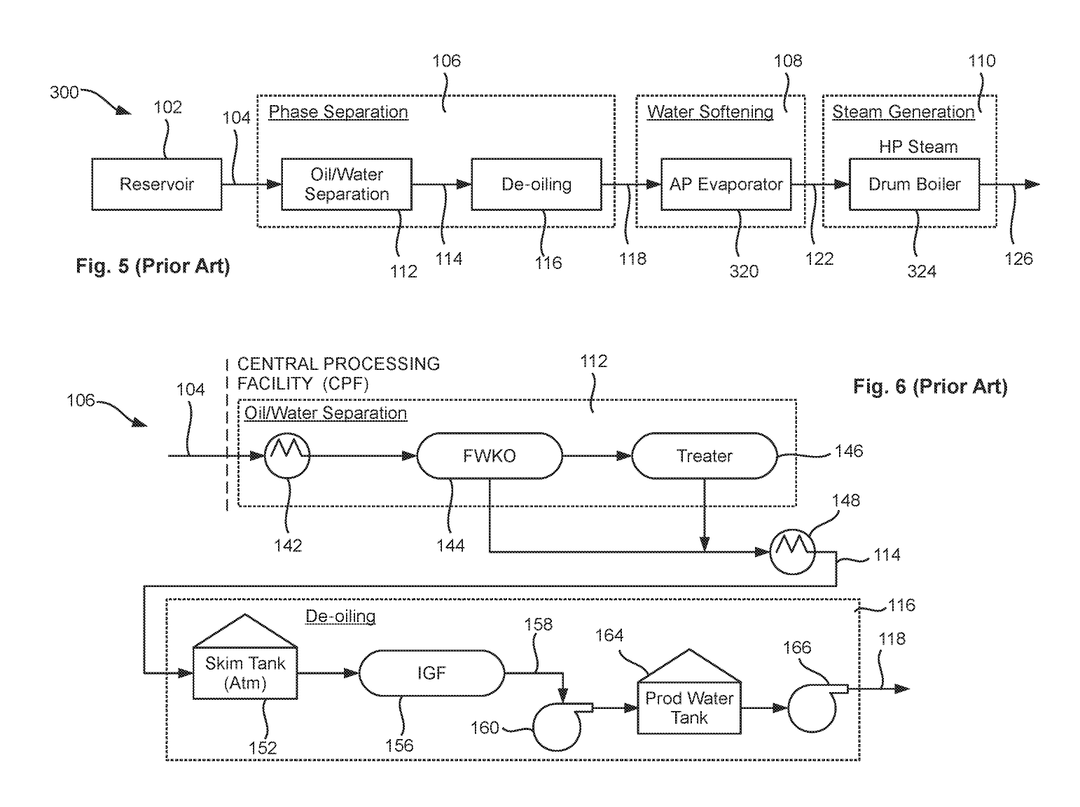

FIG. 5 is a schematic diagram of another prior-art, three-stage water treatment process 300 for enhanced oil recovery. The process 300 uses evaporator and drum boiler, and is denoted as an evaporator-drum boiler process. The evaporator-drum boiler process 300 recently becomes more popular due to the tighter regulation in water management.

The process 300 is similar to the process 100 of FIG. 1 except that the process 300 uses an atmospheric pressure (AP), front-end evaporator 320 for water softening 108, and a drum boiler 324 for steam generation 110. Accordingly, some devices used in the process 300 are different to those of the process 100.

FIG. 6 shows the devices and detailed process of the phase separation stage 106 of the process 300, which are usually located in a CPF. As can be seen, the phase separation 106 of the process 300 is similar to that of the process 100 except that, in the process 300, de-oiling 116 is a two-step process using a skim tank 152 and an IGF 156. No ORF is required.

The omission of ORF is benefited from the use of the AP front-end evaporator 320 in the water softening stage 108, which is less sensitive to oil contamination in the produced water 118, and thus does not require high-level de-oiling.

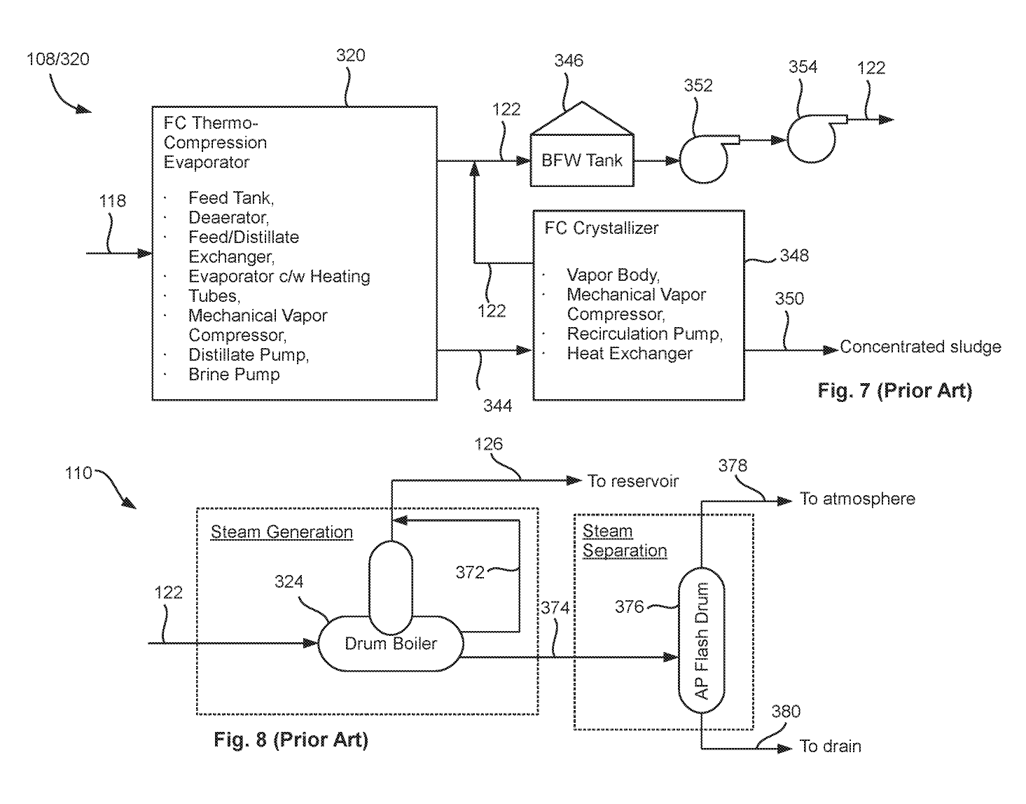

FIG. 7 shows the devices and detailed process of the water softening stage 108 of the process 300. As shown, the produced water 118 is fed into a forced circulation (FC) thermo-compression, front-end evaporator 320.

Many front-end evaporators are forced circulation, mechanical vapor compression evaporator packages, comprising a vapor drum with vertical or horizontal heating tubes, and necessary components such as feed tank, deaerator, feed/distillate exchanger, mechanical vapor compressor, recirculation pumps, distillate pump, brine pump, and the like.

To ensure proper working of the evaporator 320, it is necessary to condition and remove O₂, CO₂ and SO₂ from the produced water 118 to protect the evaporator from corrosion or fouling. In many cases, the evaporator package is supplied with its own conditioning tank and deaerator. In other cases, the produced water tank 164 upstream of the evaporator 320 is used as the conditioning tank.

Front-end evaporators 320 are often used when no disposal well is available, or when a producer cannot obtain the required produced water recycle efficiency (which may be otherwise produced using the process of FIG. 1). Comparing to the WLS-OTSG process 100, a large front-end evaporator 320 followed by a drum boiler 324 costs less than adding a backend evaporator to the process 100.

The evaporator 320 uses distillation to separate water from impurities. The distilled water 122, i.e., softened water, is discharged into a boiler feed water (BFW) tank 346 for storage, and sludge 344, which comprises impurities and some water, is discharged into a FC crystallizer 348, which may comprise necessary components such as vapor body, mechanical vapor compressor, recirculation pump, heat exchanger and the like. The FC crystallizer 348 further separates water from impurities, discharges separated water 122 to the BFW tank 346 for storage, and discharges concentrated sludge 350 for disposal.

The softened water 122, i.e., the boiler feed water, may be discharged from the BFW tank 346 and is pumped via a low pressure (LP) BFW pump 352 and a HP BFW pump 354 to the drum boiler 324 for steam generation.

FIG. 8 shows the devices and detailed process of the steam generation stage 110 of the process 300. As shown, the boiler feed water 122 is fed into a drum boiler 324 to generate HP steam 126 for injecting into reservoir 102 or oil wells. As is known in the art, drum boiler 324 is a “water tube” boiler with water on the tube side for high pressure steam generation, typically in the range of 7,000-9,000 kPag. The drum boiler 324 has tendency of fouling and requires high purity boiler feed water 122 that may be obtained by evaporation, and may not be able to obtain via chemical treating of produced water.

Injection wells can tolerate small amount liquid in the injection steam without compromising the measurement, accounting reporting and other regulatory requirements. This allows the continuous blowdown 372 to be re-combined with the dry HP steam for a wet injection stream while the intermittent blowdown 374 is flashed into an AP flash drum 376 to further reduce its volume. The flashed vapor 378 is discharged in to the atmosphere in the form of vapor, and water 380 is discharged into the plant open drain system There is negligible impurities in water 380 because of the high quality distillate nature of boiler feed water 122.

In some situations, the process 300 may comprise two evaporators 320 coupled in series, followed by a single crystallizer 348.

The process 300 also has several drawbacks. For example, while the drum boiler 324 has higher working pressure, larger capacity and is more efficient comparing to the OTSG, its initial cost is high.

The initial cost of the front-end evaporator 320 is also high because of the required large surface areas and the number of auxiliary equipment. While the energy efficiency of the front-end evaporator 320 is high thanks to the latent heat reuse and good heat transfer, the overall energy efficiency of the system 300, however, is lowered because of cyclic phase changes. The distillates condensed from the steam vapor in the evaporator 320 needs to be re-evaporated in the drum boiler 324. Compared to the process 100 using WLS 120 and WAC ion exchange unit 186, the total cost of the evaporator-drum boiler process 300 may be merely marginally lower, but the greenhouse gas emissions of the process 300 are much higher.

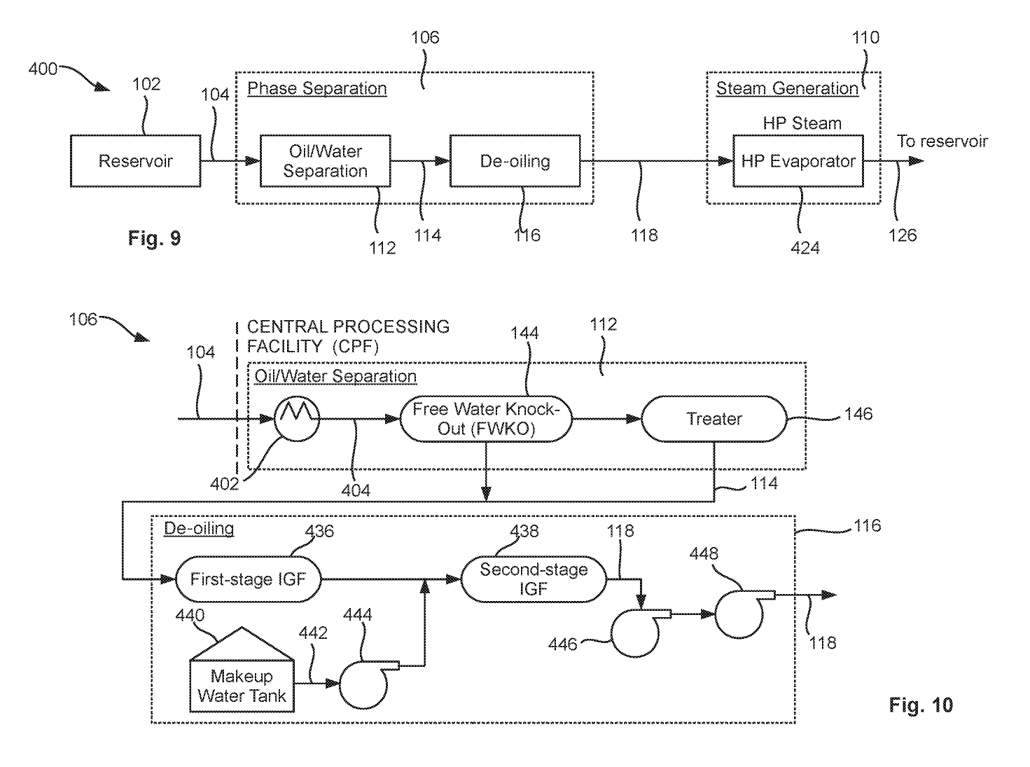

FIG. 9 is a schematic diagram of a two-stage water treatment process 400 for enhanced oil recovery such as SAGD, according to one embodiment of this disclosure. The process 400 disclosed herein is simple and energy efficient. Compared to the prior-art processes 100 and 300, the process 400 does not comprise any water softening stage.

As shown, the emulsion 104 produced from the reservoir 102 is first processed at a phase separation stage 106 to obtain produced water 108 from the emulsion 104. The produced water 118 is then directly fed into an HP evaporator 424 in the steam generation stage 110 for steam generation. In other words, the process 400 uses the HP evaporator 424 and a pressurized system to generate HP steam 126 directly from the produced water 118. The water softening stage is thus eliminated, and a simplified de-oiling process 116 is used to supply high temperature, high pressure water to the evaporator 424.

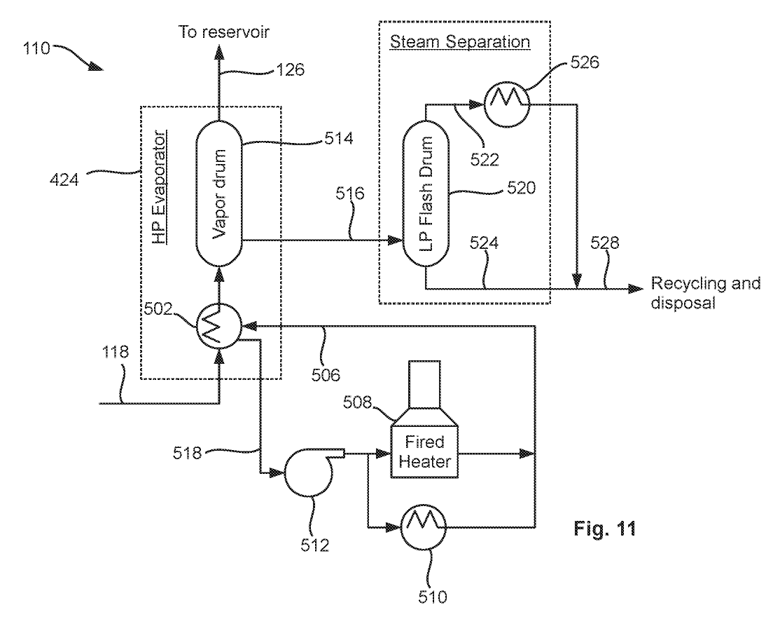

FIG. 10 shows the devices and detailed process of the phase separation stage 106 of the process 400, which are usually located in a CPF.

As shown, an inlet heat exchanger 402 is used to first adjust the emulsion 104 to a process temperature sufficiently high to maintain silica being dissolved therein, to achieve the best separation efficiency in the downstream FWKO 144 and treater 146, or in a flash treating scenario, to heat the high pressure emulsion in order to effectively remove bulk water in a high temperature inverted separator.

In various embodiments, the process temperature is set based on various factors such as the viscosity and specific gravity profiles of the emulsion 104, the treating method (e.g., dilute treating or flash treating process), and the like. In some embodiments, the inlet heat exchanger 402 adjusts the emulsion 104 to a process temperature above 100° C. In some other embodiments, the inlet heat exchanger 402 adjusts the emulsion 104 to a process temperature between about 100° C. and about 250° C. In yet some other embodiments, the inlet heat exchanger 402 adjusts the emulsion 104 to a process temperature between about 100° C. and about 200° C. In still some other embodiments, the inlet heat exchanger 402 adjusts the emulsion 104 to a process temperature between about 140° C. and about 150° C.

In this embodiment, the emulsion 104 produced from the reservoir 102 is a hot oil/water stream, and the inlet heat exchanger 402 cools the emulsion 104 down to a process temperature between about 140° C. and about 150° C., which is suitable for operation of traditional downstream devices such as FWKO 144 and treater 146, and is still sufficiently high to maintain silica being dissolved in the emulsion 104.

The temperature-adjusted emulsion 404 discharged from the inlet heat exchanger 402 is then fed into a three-phase separator 144 such as a FWKO unit, which separates the majority of water from the oil and water mixture 104 using gravity. The oil separated by the FWKO 144, still containing some water, is fed into a treater 146 for desalting and dewatering.

The separated water 114 discharged from the FWKO 144 and the treater 146 is then processed by de-oiling 116 for removing residual oil from the separated water 114.

The de-oiling 116 of the process 400 is simplified by using two a first-stage and a second-stage pressurized IGFs 436 and 438 coupled in series for removing oil and fine solids therein. Both IGFs 436 and 438 operate at about the same temperature as the FWKO 144 and the treater 146, e.g., between about 140° C. and about 150° C. in this embodiment, thereby eliminating the water cooler 148 used in the process 100 of FIG. 1.

Optionally, makeup water 442 may be supplemented into the second-stage IGF 438 from a makeup water tank 440 via a transfer pump 444, for the purposes of supplying startup water, makeup water, and decoupling production from steam injection.

The produced water 118 discharged from the second-stage IGF 438 typically has a pressure between 300 kPag and 500 kPag. The produced water 118 is further pressurized to a higher pressure, e.g., between about 6000 kPag to 10000 kPag for an ANSI Class 600 or 900 system, and pumped to the HP evaporator 424 in the steam generation stage 110, via an HP evaporator booster pump 446 and an HP evaporator charge pump 448. In this embodiment, the HP evaporator charge pump 448 has a high net positive suction head (NPSH) requirement and need a booster pump 446 to avoid cavitation.

In the de-oiling 116 of the process 400, both IGFs 436 and 438 can remove free or entrained oil to a level that does not cause severe foaming in the HP Evaporator 424. Consequently, as will be described below, the process 400 does not comprise any WAC ion exchange unit, WLS, or fired boilers such as drum boilers, leading to less risk of oil channeling.

In addition to its primary function of de-oiling, the second-stage IGF 438 may also serve as a mixing drum for removing the entrained non-condensable impurities originated from the make-up water 442. If needed, pre-conditioning chemicals (not shown) can be added to the inlet of the HP evaporator booster pump 446 or the inlet of the HP evaporator charge pump 448.

FIG. 11 shows the devices and detailed process of the steam generation stage 110 of the process 400, which uses an HP evaporator 424 to generate HP steam 126 directly from the produced water 118 while solids and other contaminants in the produced water 118 are concentrated in the high pressure blowdown.

As shown, the produced water 118 is fed into the heating tubes 502 of the HP evaporator 424, and is heated and vaporized by hot heat medium 506 such as hot heating-oil from various energy resources such as a solar parabolic trough system or other solar power concentrating collectors, a fired heater, and/or a wind turbine (not shown).

In this embodiment, solar power from a solar collector 510 is used for heating the heating-oil 506 to a high temperature, e.g., 400° C. or higher. As solar energy is directed used for heating, the system avoids the traditional energy conversion from solar power to electricity and then to heat, increasing energy efficiency, and eliminating the need for turbine generator and thermal storage tanks.

In this embodiment, a secondary heater 508, e.g., a fired heater such as a tubular heater having cylindrical tubes, is also used as a secondary heating source for compensating for intermittent solar power. In particular, the fired heater 508 is automatically shut down when solar power is sufficient for maintaining the heating-oil 506 at a designated temperature of 400° C. or higher (e.g., during daytime), and is automatically started when solar power is insufficient (e.g., during nighttime and during daytime in overcast days). When the fired heater is turned on, the heating power thereof is automatically adjusted to compensate for the solar power for maintaining the heating-oil to the designated temperature.

After heating and vaporizing the produced water 118, the temperature-reduced heating-oil 518 is pumped, via a heat-oil pump 512, back to the fired heater 508 and/or the heater 510 for re-heating up.

In an alternative embodiment, the same heating-oil may also be used as the heat medium for cooling the hot emulsion 104 in the inlet heat exchanger 402 (FIG. 10). In this embodiment, at least a portion of heating-oil 518 exiting from the heating tubes 502 is cooled by an aerial cooler (not shown) and then directed to the inlet heat exchanger 402 for use as cooling medium in the inlet heat exchanger 402 for cooling the hot emulsion 104. The heated heating-oil exiting from the inlet heat exchanger 402 is then directed to the fired heater 508 and/or heat exchanger 510 via the heat-oil pump 512 to heat up. Therefore, in this embodiment, the use of second cooling medium such as glycol is eliminated, and the energy consumption of the fired heater 508 and/or heat exchanger 510 is reduced. Of course, in some other embodiments, heating-oil 506 exiting from the heating tubes 502 may alternatively be used in other utility coolers before being directed to the fired heater 508 and/or heat exchanger 510 for heating up.

Referring again to FIG. 11, in the HP evaporator 424, the heating tubes 502 vaporize water 118 to generate steam 126 in the vapor drum 514. The generated HP steam 126 is discharged from the vapor drum 514 for injection into the reservoir 102 for oil production.

The HP evaporator 424 can generate HP steam 126 with low cost. The energy needed for heating and evaporating the feed water stream 118 is from the hot heat medium 506 in the heating tubes 502, and is powered by an inexpensive, low pressure rating, fired heater, and optionally, heater(s) with renewable energy integration. Further, compared to other heat transfer medium such as glycol, heating-oil has a much higher degradation temperature, enabling a high temperature difference to achieve higher heat transfer coefficient in the heating tubes 502 of the HP evaporator 424.

Referring again to FIG. 11, the high pressure blowdown 516 discharged from the HP evaporator 424, which comprises impurities and some water, is fed into an LP vapor-liquid separator or flash drum 520, in which steam vapor 522 and liquid 524 are separated. The flashed steam vapor 522 is condensed and sub-cooled in a condenser 526, and then recombined with the liquid 524 to cool down the liquid 524 and form a warm, low pressure blowdown 528, which is then de-watered in a centrifuge (not shown), or disposed.

The steam 126 from the HP evaporator 424 may still contain a small amount of impurities that are saturated in the steam through equilibrium. However, such a small amount of impurities therein would not cause any operation problems in the pipeline, nor would these impurities cause the reservoir 102 to foul.

While some of above-described devices may be located in the CPF, the HP evaporator 424 may be located near a disposal well or in a production wellpad/reservoir 102 to avoid expensive high pressure steam pipelines, and to lower the maximum working pressure for the HP evaporator 424 to simply match the pressure for injection and disposal wells. The concentrated blowdown from the flash drum 520 is directly pushed down to the cavern by pressure.

By replacing the OTSG 124 in process 100 or the drum boiler 324 in process 300 with an HP evaporator 424, the process 400 shifts the focus from the boilers acceptance (with regard to impurity in boiler feed water) to the reservoir acceptance (with regard to impurity in HP steam).

The process 400 described above does not need water treatment. In some embodiment, a specifically designed HP evaporator 424 is used for achieving relatively salting and scaling free, capable of producing HP steam 126 directly from the produced water 118.

Below, a prior-art, rising-film long-tube vertical (RFLTV) evaporator and a prior-art, revised rising-film long-tube vertical (RRFLTV) evaporator are first described for the purposes of illustration and comparison, and then an HP evaporator with fouling resistance according to one embodiment of this disclosure is described with comparison to the prior-art RFLTV evaporator.

RFLTV evaporators are once-through devices (where water only passes through the device once). While inexpensive, RFLTV evaporators have very low velocity and poor heat transfer efficiency, and thus are generally not suitable for salting and severely scaling applications.

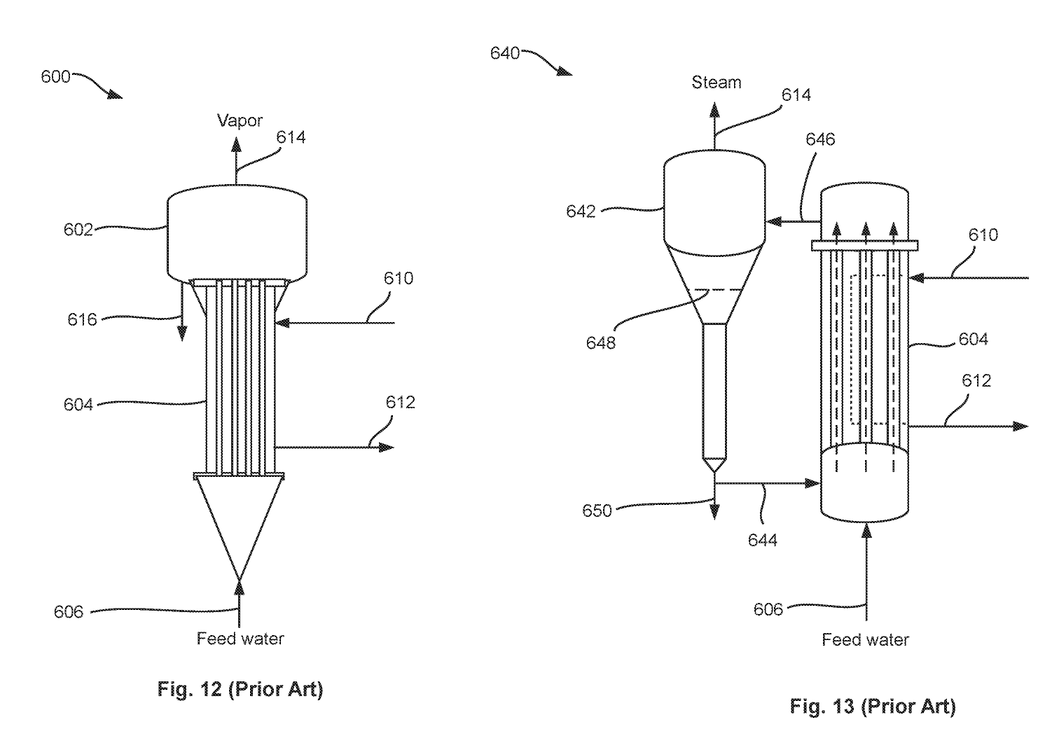

FIG. 12 is a schematic diagram of a prior-art RFLTV evaporator 600. As shown, the RFLTV evaporator 600 comprises an integrated vapor drum 602 and heating element 604. The heating element 604 comprises vertical tubes for receiving feed water 606 injected from the bottom thereof via an inlet (not shown). A heating channel on the outer surface of the vertical tubes receives heating medium 610 such as heating steam.

The heating medium 610, usually steam or oil, in the heating channel heats and evaporates the water 606 in the vertical tubes. After heat exchange, the temperature-reduced heat medium 612 is discharged from the evaporator, and is reheated by an energy source (not shown).

After heat exchange, water 606 in the vertical tubes of the heating element 604 is vaporized, increasing the pressure inside the vertical tubes. The pressure in the vertical tubes of the heating element 604 forces liquid therein to form a thin film on the inner surface thereof. The vapor 614 moves to the top of the evaporator 600 at a high velocity, and is discharged therefrom via a vapor outlet (not shown). As the vapor quickly moves upward, the thin liquid film also rises towards the top of the heating element 604. Un-vaporized liquid 616 is discharged through a liquid outlet.

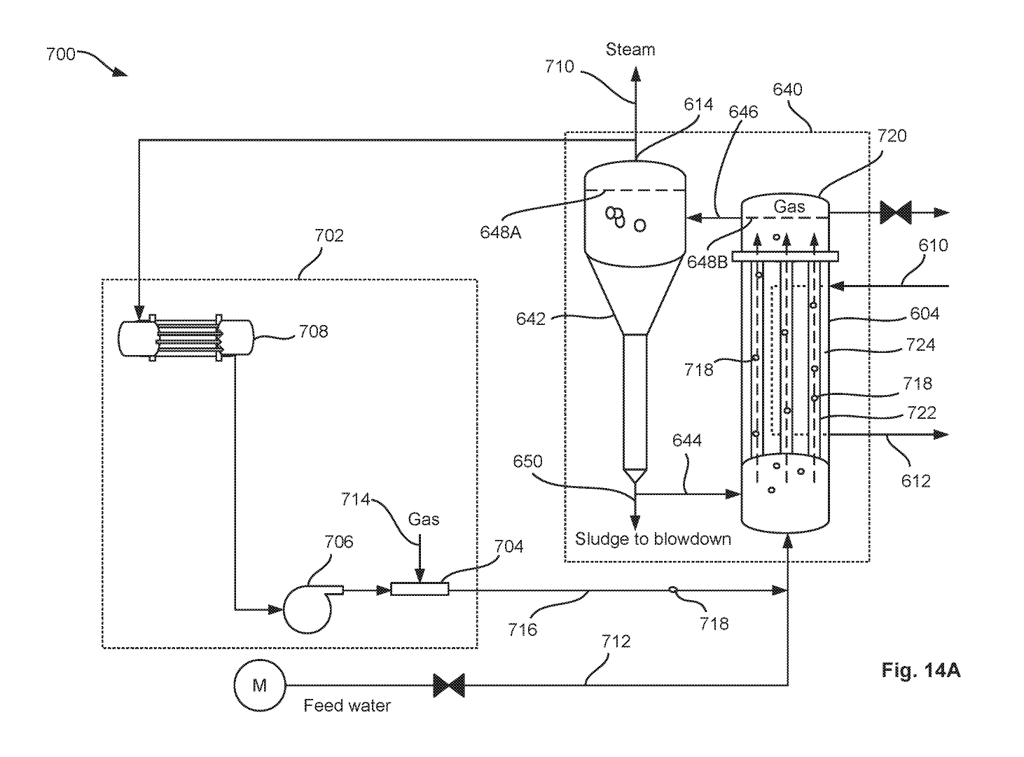

FIG. 13 is a schematic diagram of a prior-art, RRFLTV evaporator 640, which is commonly used in, e.g., food industry for concentrating milk. The RRFLTV evaporator 640 comprises a vapor drum 642 for separating vapor and liquid therein. The vapor drum 642 is coupled to a heating element 604 via a bottom connection pipe 644 for liquid communication therebetween, and via a top connection pipe 646 for steam communication therebetween. Feed water 606 is injected into the heating element 604 from the bottom thereof, and is heated by hot heating medium 610. Steam 614 and hot, bubble-mixed liquid enter the vapor drum 642 from the top connection pipe 646, accumulates in a top portion of the vapor drum 642, and is discharged therefrom via a vapor outlet (not shown).

Condensed vapor and un-vaporized liquid fall to a lower portion of the vapor drum 642, and accumulate therein, forming a vapor-liquid interface 648. The accumulated liquid, including condensed water, flows via the bottom connection pipe 644 back to the heating element 604 through natural circulation. Concentrated sludge 650 is discharged from the bottom of the vapor drum 642.

Natural circulation in the RRFLTV evaporator 640 is created by keeping the vapor-liquid interface 648 low in the vapor drum 642, making liquid flash in the heating tubes of the heating element 604 and circulate because of the thermal expansion of the flashed vapor.

The RRFLTV evaporator 640 is not suitable for salting and severe scaling applications, as flashing in the heating tubes aggravates scaling, fouling and slugging.

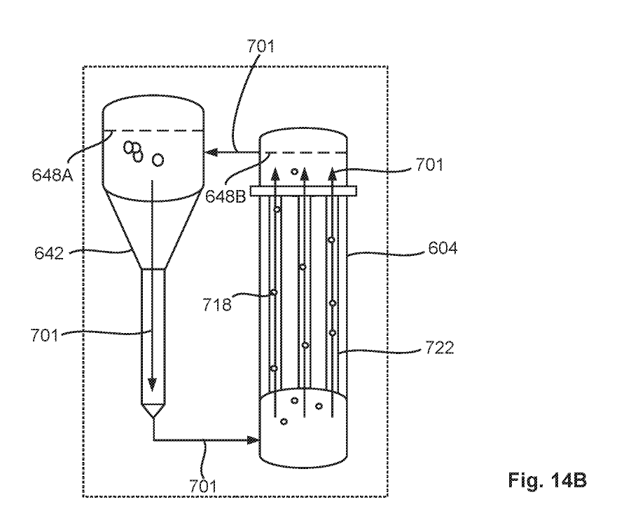

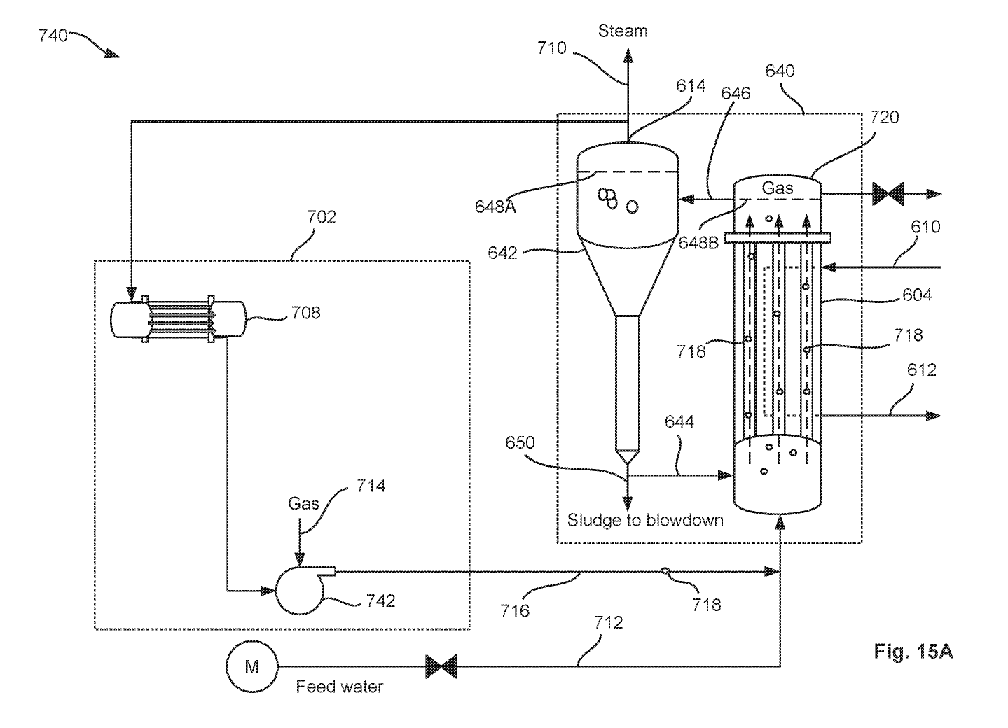

FIG. 14A is a schematic diagram of an HP, gas induced circulation (GIC) evaporator 700 having a sparger/pump assembly, according to an embodiment of this disclosure. The HP GIC evaporator 700 disclosed herein may be used as the HP evaporator 424 in the process 400.

As shown, the GIC evaporator 700 comprises an RRFLTV evaporator 640 for steam generation, and a bubble creation assembly 702 for generating bubbles for use in the RRFLTC evaporator 640. In the RRFLTV evaporator 640, the heating element 604 may be integrated with the vapor drum 642, or may be separated therefrom by in fluid communication therewith, as described above.

The heating element 604 comprises one or more vertical heating tubes 722 for receiving feed water 712 injected from the bottom thereof via an inlet (not shown). A heating channel 724 on the outer surface of the vertical tubes 722 receives heating medium 610 such as heating steam.

A steam/liquid interface 648A is maintained in the vapor drum 642 separating steam thereabove and liquid therebelow, and a steam/liquid interface 648B is also maintained in the heating element 604 separating gas thereabove and liquid therebelow. In this embodiment, the steam/liquid interface 648B in the heating element 604 is maintained at the same or higher level (or elevation) of the top connection pipe 646, and the steam/liquid interface 648A in the vapor drum 642 is maintained at a level higher than the steam/liquid interface 648B. Therefore, the heating tubes are entirely submerged in liquid, avoiding flashing and therefore scaling in the heating tubes 722. There is no steam generated in the heating tubes 722, and the feed water 712 is heated to its saturate bubble point in the heating tubes 722 before entering the vapor drum 642 for both steam generation and separation. The setting of the steam/liquid interfaces 648a and 648B and gas bubble injection also create difference in static head, allowing the circulation of bubble-mixed liquid between heating tubes 722 and the vapor drum 642 to mitigate salting and other forms of fouling in both components

The bubble creation assembly 702 comprises a sparger 704, a sparger pump 706 and a liquid source. In this embodiment, the liquid source is a steam condenser 708 for making clean sparger motive liquid from the produced steam 710.

Similar to the above description with respect to FIG. 13, feed water 712 is injected from the bottom of the heating element 604 of the RRFLTV evaporator 640, and is heated by hot heating medium 610 to generate steam 710.

A small portion of the produced steam 710 is fed to the steam condenser 708 to condense to water, which is then pumped to the sparger 704 via the sparger pump 706.

The sparger 704 also receives high pressure gas 714 such as pipeline gas or other non-condensable gas or steam, and generates miniscule gas bubbles 718 in the condensed water. The sparger 704 injects the high pressure gas 714 into the condensed water stream at a controlled flow rate to create bubbles therein. The gas bubble mixed water stream 716 is discharged from the sparger 704 and injected to the heating element 604.

The gas bubbles 718 in the heating element 604 ensures uniform static head, velocity and heat transfer coefficient along the entire vertical tubes of the heating element 604. The gas bubbles 718 induce and improve the circulation of bubble-mixed liquid between the heating element 604 and the vapor drum 642, reducing the risk of fouling and improving heat transfer. FIG. 14B shows the circulation (indicated by arrows 701) of bubble-mixed liquid between the heating element 604 and the vapor drum 642.

As those skilled in the art appreciate, a small fraction of gas bubbles 718 is discharged with the steam 710. Such a steam/gas mixture may be injected to reservoir 102 for enhanced oil production. In this embodiment, an accumulation head 720 above the heating tubes 722 comprises dead cap for trapping and collecting the bubble gas. The collected gas may be periodically removed therefrom the heating element 604.

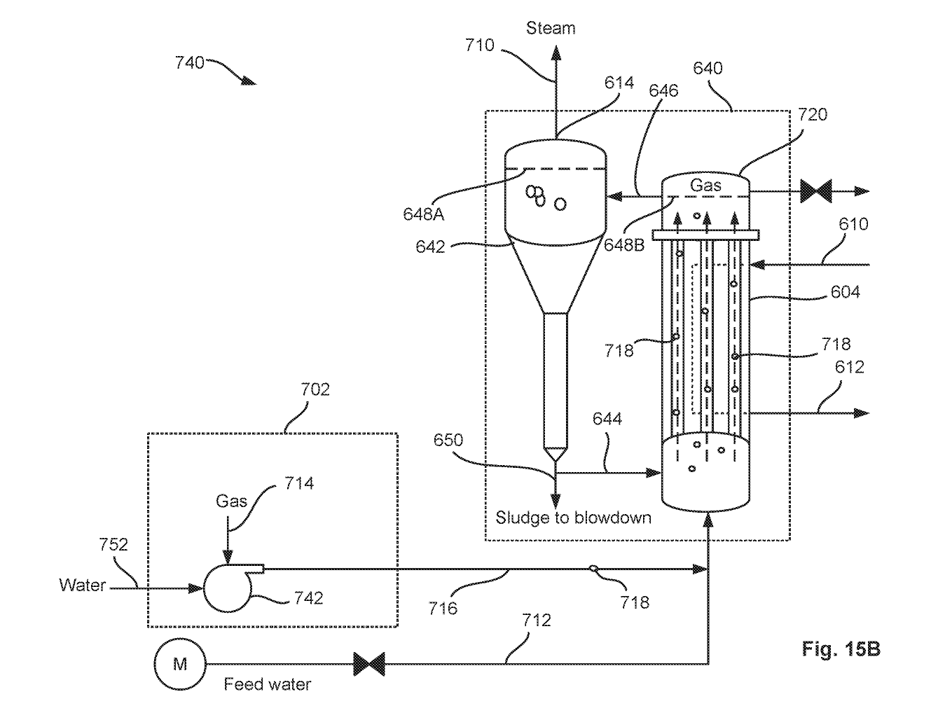

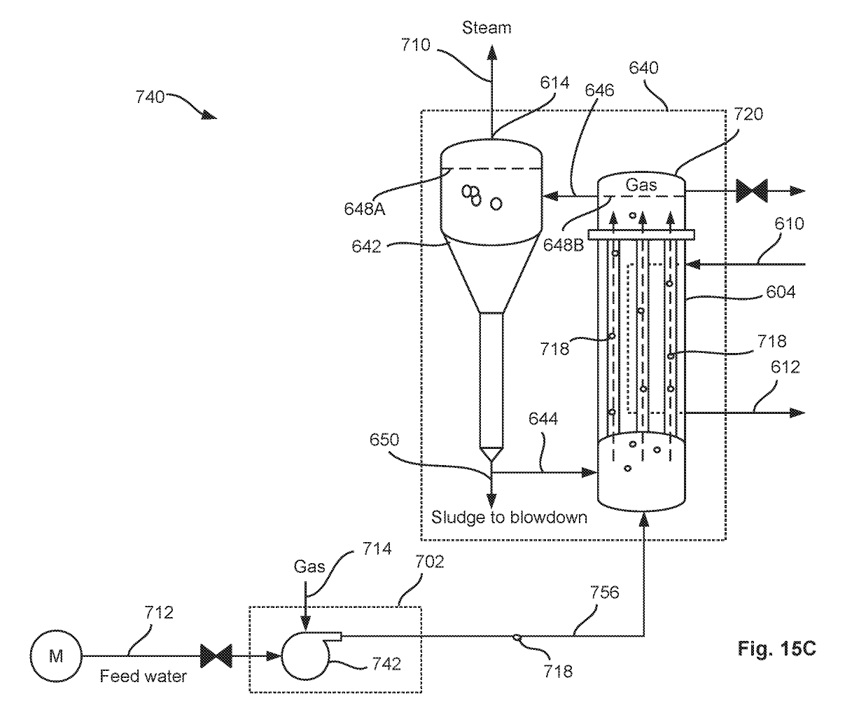

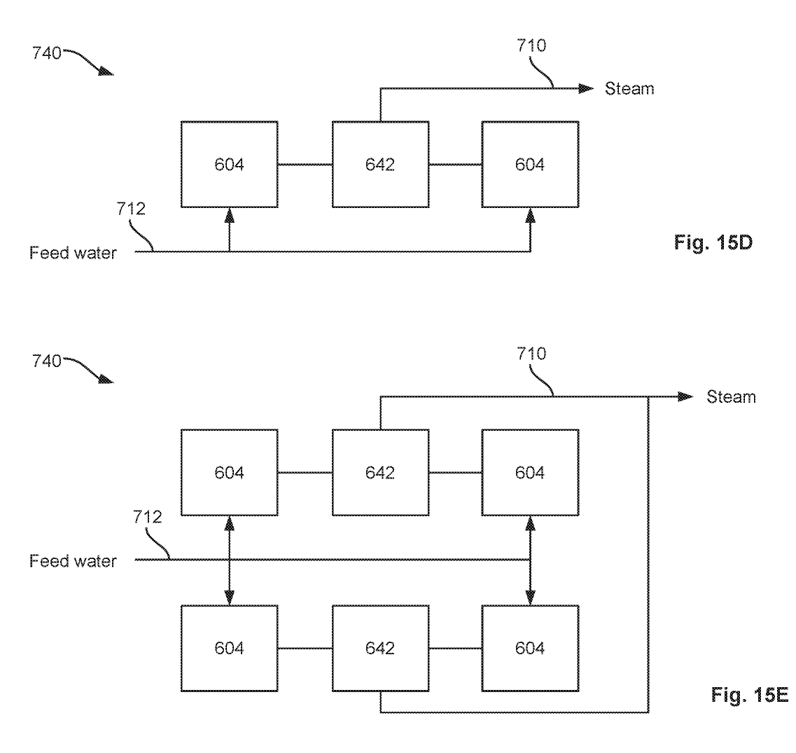

FIG. 15A is a schematic diagram of an HP GIC evaporator 740 having a bubble pump and using condensed steam for bubble generation, according to an alternative embodiment of this disclosure. The HP GIC evaporator 740 disclosed herein may be used as the HP evaporator 424 in the process 400.

The GIC evaporator 740 is similar to the evaporator 700 of FIG. 14A, except that, in this embodiment, the evaporator 740 does not comprise any sparger. Instead, the evaporator 740 comprises a bubble pump 742 receiving water from the condenser 708 and receiving gas 714 for generating miniscule bubbles 718 in water 716.

FIG. 15B is a schematic diagram of an HP GIC evaporator 740 using an external water source for bubble generation, according to yet another embodiment of this disclosure. The HP GIC evaporator 740 disclosed herein may be used as the HP evaporator 424 in the process 400.

The GIC evaporator 740 is similar to the evaporator 700 of FIG. 15A, except that, in this embodiment, the evaporator 740 does not use water condensed from the evaporator vapor drum 642. Instead, clean water 752 from an external water source (not shown) is fed into the bubble pump 742 for generating water stream 716 with miniscule bubbles 718 mixed therein.

FIG. 15C is a schematic diagram of an HP GIC evaporator 740 using the feed water for bubble generation, according to still another embodiment of this disclosure. The HP GIC evaporator 740 disclosed herein may be used as the HP evaporator 424 in the process 400.

The GIC evaporator 740 is similar to the evaporator 700 of FIG. 15B, except that, in this embodiment, gas 714 is injected into the feed water 712 for generating a bubble-mixed feed water stream 756 with miniscule bubbles 718 mixed therein.

In some alternative embodiments, an educator/pump combination, an injection fitting or the like may be used as the bubble generator for generating miniscule bubbles 718.

In some alternative embodiments, the GIC evaporator may comprise one or more heating elements 604 and/or one or more vapor drums 642. Each heating elements 604 may be in fluid communication with one, multiple or all vapor drums 642, and each vapor drum 642 may be in fluid communication with one, multiple or all heating elements 604. Isolation valves may be used for adjusting the fluid communication between heating elements 604 and vapor drums 642.

FIG. 15D is a schematic diagram of high-pressure, GIC evaporator 740 comprising one vapor drum 642 and two heating elements 604, according to one embodiment of this disclosure. The two heating elements 604 are coupled in parallel, and each heating element 604 is coupled to the vapor drum 642 in a manner similar to that of FIGS. 14A to 15C.

FIG. 15E is a schematic diagram of high-pressure, GIC evaporator 740 comprising two vapor drum and four heating elements, according to another embodiment of this disclosure. The four heating elements 604 are coupled in parallel, and each vapor drum 642 is in fluid communication with two heating element 604 in a manner similar to that of FIG. 15D.

The HP GIC evaporator 700 or 740 disclosed herein may be used in various applications. As described above, in some embodiments, the HP GIC evaporator 700 or 740 may be used in the water treatment system 400 for steam generation.

In some other embodiments, the GIC evaporator 700 or 740 may be used for treating OTSG blowdown. As described above, OTSG can produce approximately 80% wet steam and 20% blowdown based on treatment of a typical produced water with lime softener process. Most of the blowdown is recycled with the remainder being disposed. The GIC evaporator 700 or 740 can be used for this application with exceptional cost, energy and operational efficiency by taking advantage of the high pressure steam on site.

In some embodiments, the GIC evaporator 700 or 740 may comprise more than one heating element 604.

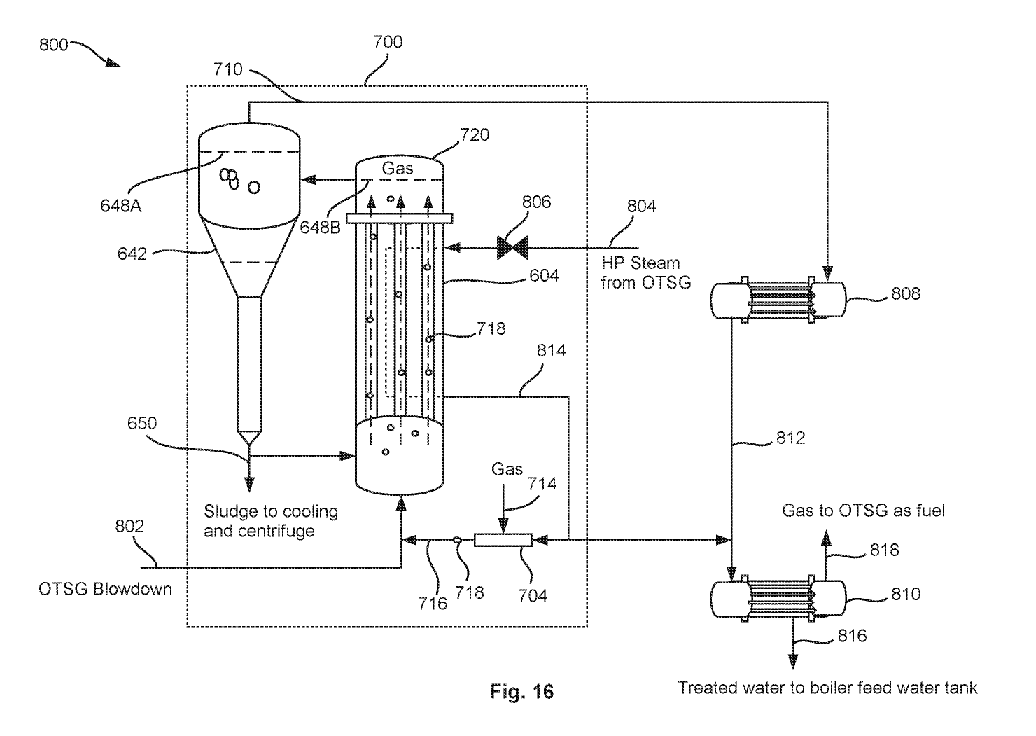

FIG. 16 shows a system and process 800 of using the GIC evaporator 700 to treat OTSG blowdown in one embodiment. Those skilled in the art appreciate that the GIC evaporator 740 can alternatively be used.

In this embodiment, high pressure steam 804 from OTSG is used as the hot heating medium of the heating element 604 for treating OTSG blowdown 802. Therefore, no fired heater or other external power source is required for heating the heating element 604, and the OTSG blowdown is treated with reduced cost and simplified operation. In this embodiment, the GIC evaporator 700 is operated at a low pressure sufficient to drive treated water 816 to the boiler feed tank without pumping. The velocity and the heating transfer coefficient are controlled in the heating tubes of the heating element 604.

As shown, high pressure steam 804 from OTSG is letdown, i.e., reduced to a low pressure, by a letdown valve 806, and is then supplied to the heating element 604 as heating steam. After heat exchange, the heating steam 804 is condensed to water (denoted as heating water) 814 and discharged from the heating element 604. A majority of the heating water 814 is fed into a glycol trim cooler 810, and a small portion of the heating water 814 is fed into the sparger 704 as motive liquid. The sparger 704 uses gas 714 and the heating water 814 to generate water stream 716 with gas bubbles 718 for injecting into the heating element 604.

On the other hand, OTSG blowdown 802 is first cooled (not shown) to slight below the operating temperature of the GIC evaporator 700 (to avoid flashing in the heating element 604), and then is injected into the heat element 604 of the GIC evaporator 700 from the bottom thereof. Water in the OTSG blowdown 802 is vaporized into low pressure steam 710 by the heat of the OTSG steam 804. Impurities in the OTSG blowdown 802 form concentrate sludge 650, which is discharged from the bottom of the evaporator vapor drum 642 for cooling and dewatering in a centrifuge.

The generated low pressure steam 710, including gas 714, is first discharged to a steam condenser 808 for condensation. The condensed water 812 and gas 714 is then discharged from the condenser 808 into a glycol trim cooler 810.

In the trim cooler 810, gas and water are cooled down to around 80° C. to 90° C., and are separated. Treated water 814 is discharged to boiler feed water tank, and gas is sent to OTSG as fuel.

As can be seen, the system 800 is a self-sustained system with no moving parts.

The process of FIG. 16 has a drawback of energy inefficiency due to the cyclic phase change of the product steam 710 from the evaporator 700. The product steam 712 is condensed, recycled, pumped and, if used for injecting into oil wells, eventually re-evaporated in the OTSG, costing both power and OTSG capacity.

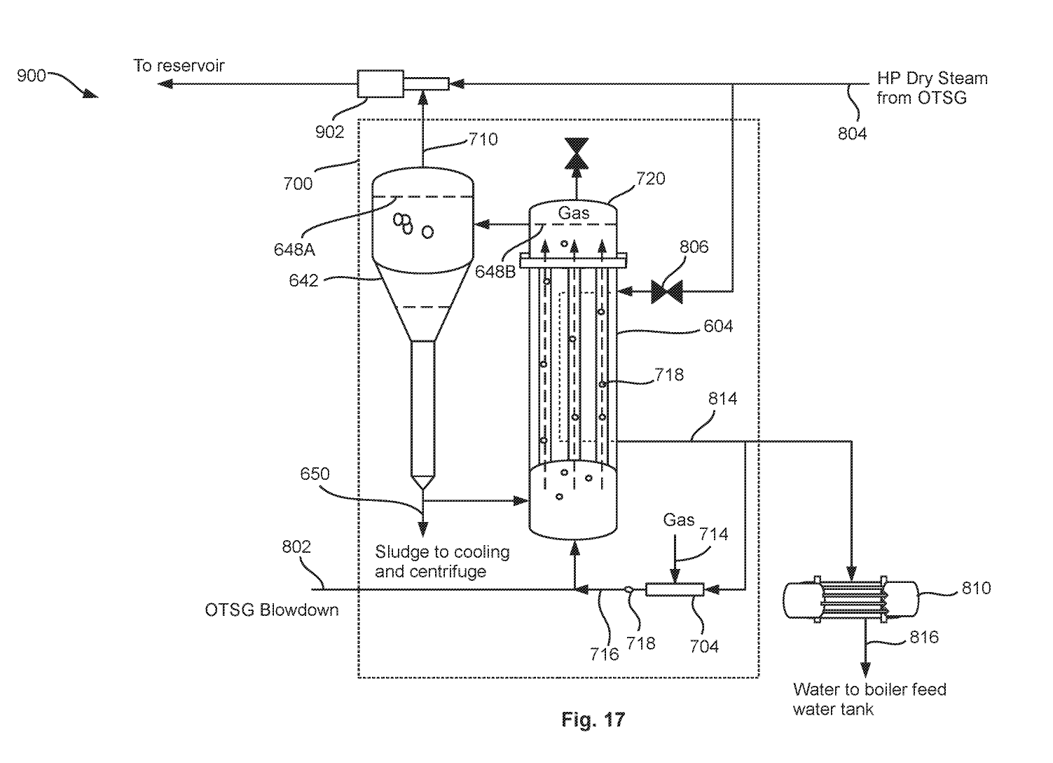

FIG. 17 shows a system and process 900 of using the GIC evaporator 700 to treat OTSG blowdown in another embodiment. Those skilled in the art appreciate that the GIC evaporator 740 can alternatively be used. The steam generated from treated OTSG blowdown is used for injecting into oil wells. In this embodiment, the GIC evaporator 700 is operated at a high pressure which balances the compression ratio of the ejector 902 and the constructability of evaporator 700.

The process 900 is similar to the process 800 of FIG. 16, and thus will only be briefly described with focus on the differences therebetween. As shown, a majority portion of the HP dry steam 804 from OTSG is sent to an ejector 902 for compressing steam 710 generated by the GIC evaporator 700, and for injecting to reservoir. A small portion of the HP dry steam 804 from OTSG, on the other hand, is used as the heating steam for the heating element 604, after reducing pressure by the letdown valve 806. After heat exchange, a small portion of the condensed heating water 814 is used by the sparger 704 for gas bubble generation, and a majority of the condensed heating water 814 is cooled down in a cooler 810, which discharges cooled water 816 to a boiler feed water tank.

By treating the OTSG blowdown 802, the generated steam 710 is injected into the ejector 902, which compress the steam 710 using the high pressure steam 804 from OTSG. The obtained high pressure steam, including both the OTSG steam 804 and the compressed steam 710, is injected to reservoir 102.

In another embodiment, a process similar to that of FIG. 16 or FIG. 17 can be used for the treatment of boiler feed water for drum boilers. In this embodiment, the GIC evaporator 700 or 740 is used to treat silica, organics, hardness and/or other contaminants from the steam vapor for a better distillate quality acceptable to the drum boiler.

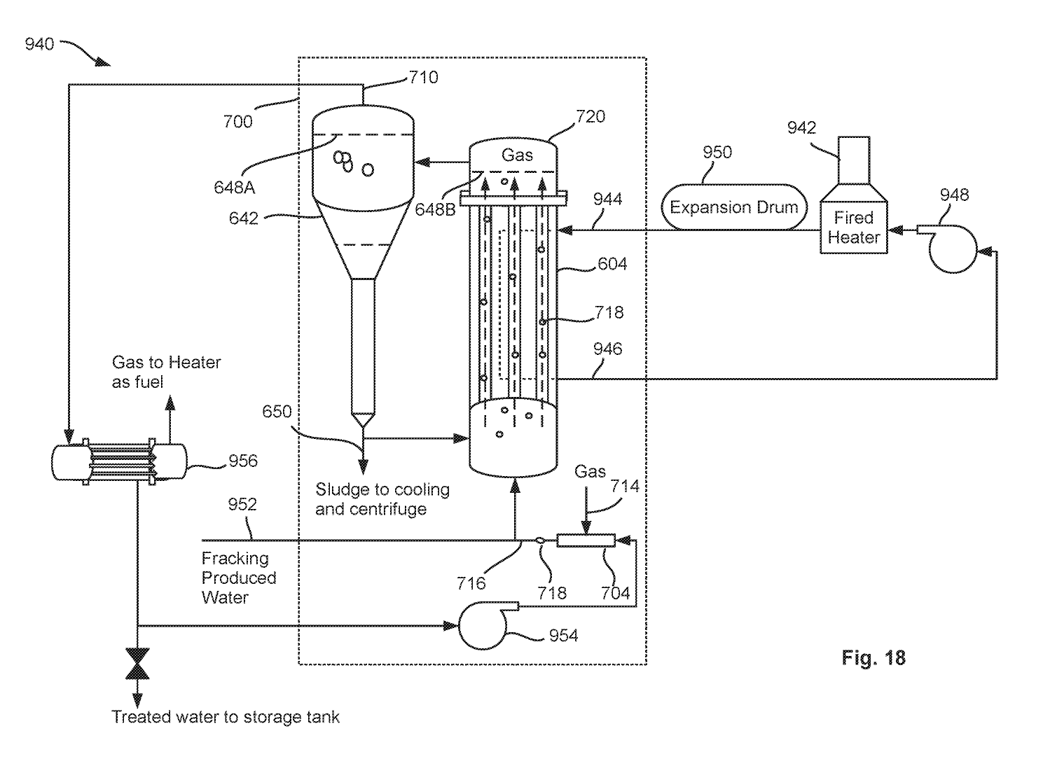

FIG. 18 shows a system and process 940 of using the GIC evaporator 700 to treat fracking produced water in another embodiment. Those skilled in the art appreciate that the GIC evaporator 740 can alternatively be used.

In this embodiment, the GIC evaporator 700 may be deployed locally at the well sites to avoid transporting water to and from a centralized water treatment plant. As shown in FIG. 18, the process 940 uses a fired heater 942 for generating hot heating fluid 944, e.g., glycol, for GIC evaporator 700, and the cooled heating fluid 946 is pumped by a thermal fluid circulation pump 948 back to the fired heater 942 for re-heating, forming a heating loop. A thermal expansion drum 950 is used for protecting the heating loop from excessive pressure.

In this embodiment, the GIC evaporator 700 is operated at a moderate temperature, making glycol a more economic choice than heating-oil.

Fracking Produced Water 952 is injected into the heating element 604 of the GIC evaporator 700 from the bottom thereof. Gas bubbles 718 are generated by a sparger 704 using gas 714 and water condensed from the steam 710. A pump 954 may be used for pumping condensed water into the sparger 704.

The steam 710 generated by the GIC evaporator 700 is fed into a condenser 956 for condensing the steam and separating gas. The separated gas is fed to the fired heater 942 as fuel. The majority of the condensed water is fed to a storage tank for storage, and a small portion of the condensed water is fed to the sparger 704 via the pump 954 for gas bubble generation.

In some embodiments, the GIC evaporator 700 or 740 disclosed herein may be configured in a modularized manner comprising a plurality of modules for ease of customization, installation and maintenance. Each module has suitable dimensions and weights to meet various requirements, e.g., transportation limits, the high load corridor of Alberta, Canada or a relevant government, the route to oil sands sites, and the like. For example, in one embodiment, each module has dimensions of an ISO standard container (e.g., ISO standard 668) or a domestic 48′ or 53′ container, and comprises a module frame for installing equipment therein.

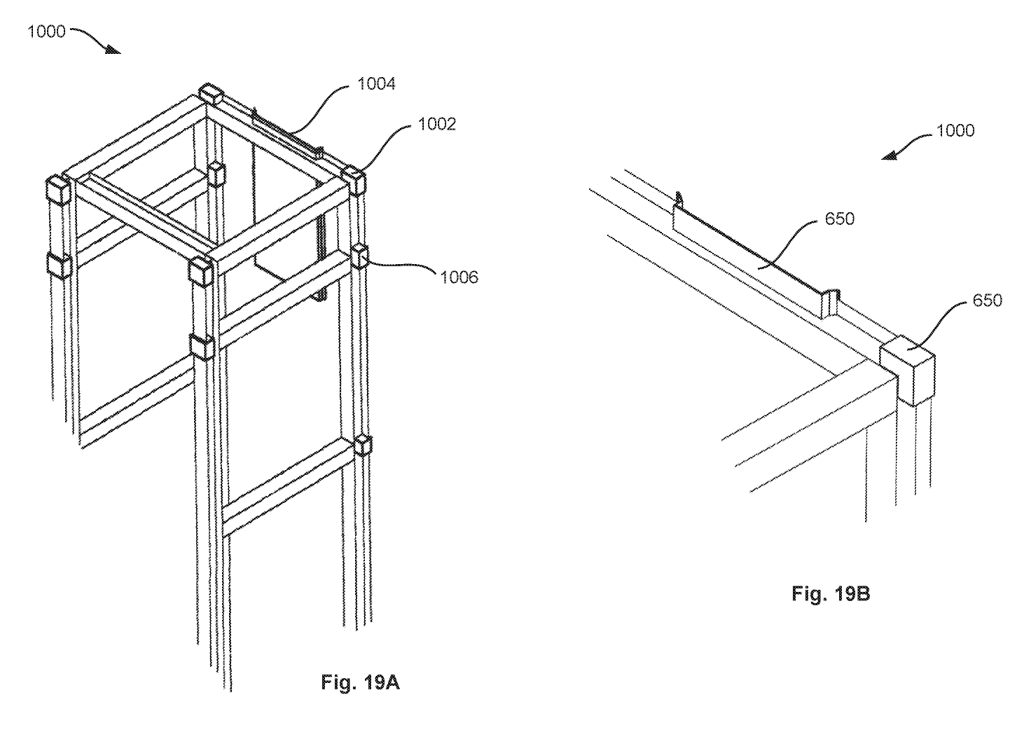

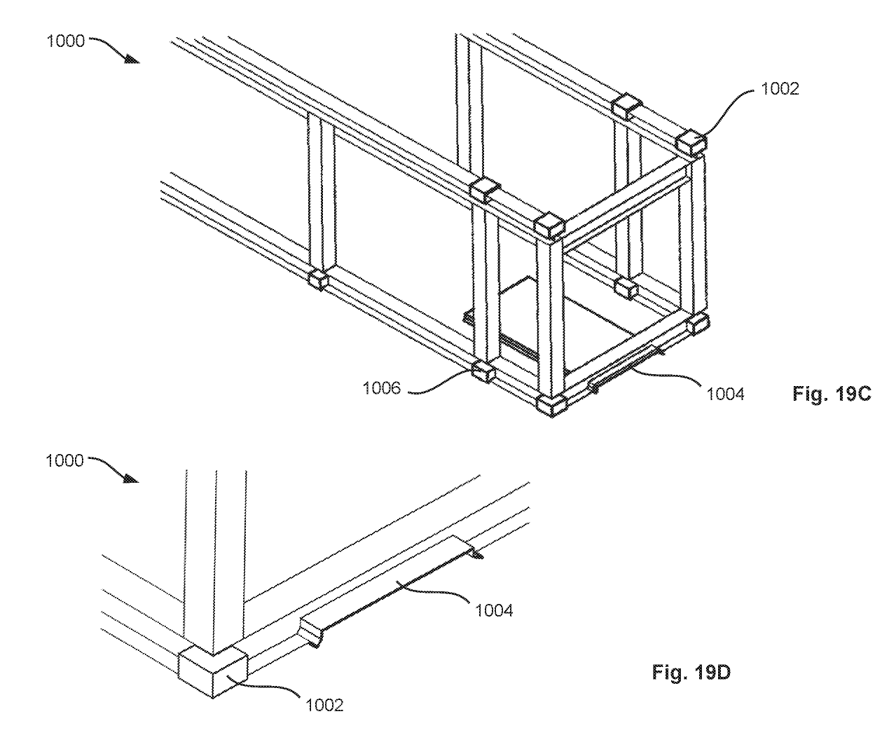

FIGS. 19A and 19B show a portion of a module frame 1000 in a vertical, operation orientation. FIGS. 19C and 19D show the same portion of the module frame 1000 of FIGS. 19A and 19B in a horizontal, transportation orientation.

The module frame 1000 is made of suitable material such as interconnected metal rails. The module frame 1000 also comprises corner castings 1002 and gooseneck 1004, allowing the container modules to be shipped via Inter-modal transportation as standard ISO containers, and typical ISO lift fittings 1006 for handling. As can be seen, the gooseneck 1004 is on a vertical side of the frame 1000 during operation, and is on a bottom of the frame 1000 during transportation. As is known in the art, the gooseneck 1004 can reduce the overall height of the truck loading the module during transportation, comparing to containers without gooseneck.

In some embodiments, the module frame 1000 comprises goosenecks 1004 only if the module frame 1000 is longer than 40′, and module frames 1000 shorter than 40′ do not comprise any gooseneck 1004.

In some embodiments, the module frame 1000 comprises lift fittings 1006 only if the module frame 1000 is longer than 40′, and each of the lift fittings are located at about 40′ from a respective corner thereof.

The division of the GIC evaporator 700 or 740 into modules depends on the functionalities, physical dimensions and weights, installation and maintenance needs and relevant government regulations of the components of the GIC evaporator 700 or 740. In one embodiment, the GIC evaporator 700 or 740 is divided into three types of modules, including vapor drum modules for fitting therein the vapor drums 642, heating element modules for accommodating the heating elements 604, and piping modules for fitting therein other components and necessary pipings of GIC evaporator 700 or 740 for connecting the vapor drum modules 642 and heating element modules 604. Each module receives the equipment and devices therein in a self-contained manner with little or no loose equipment, and provides an interconnection interface for connection to other modules.

The modules are interconnectable and may be combined to form one or more module blocks. Each module block may comprise at least one vapor drum module, at least one heating element module and at least one piping module. The modules in a module block are fluidly interconnected as required. For example, the at least one heating element module may be fluidly connected to an aqueous feed inlet line, a set of thermal fluid supply/return lines and a gas outlet line in the at least one piping module. The vapor drum module may be fluidly connected to a steam outlet line, and a sludge outlet line in the at least one piping module.

In some embodiments, the vapor drum module and/or the heating element module may further comprise integrated platforms for operating and/or maintenance.

With the modularized configuration, each module may be constructed offsite and transported to a job site for assembling to one or more module blocks and connecting to other facilities. By using isolation valves, one or more modules of an assembled module block may be isolated and removed for maintenance and/or repair while other modules in the same block are still in operation.

Alternatively, one or module blocks may be constructed offsite, and transported to a job site.

In some embodiments, the modules generally have the same sizes and/or same cross-sectional shapes, and in compliance with requirements of ISO containers (also referred to as freight containers, shipping containers, hi-cube containers, boxes, conex boxes or sea cans) for facilitating intermodal transportation. For example, the modules preferably have a standard length of 40, 45, 48, or 53 feet, in accordance with ISO standard 668 or other industrial standards regarding dimensions, ratings and fittings, to enable the modules to be transported by container trucks and lifted by standard cranes and handlers during both initial construction and plant operation stages for the cost and schedule considerations.

In some alternative embodiments, the modules may have different sizes as required. However, the sizes of the modules are preferably in compliance with those of the standard containers and standards such as ISO standard 668.

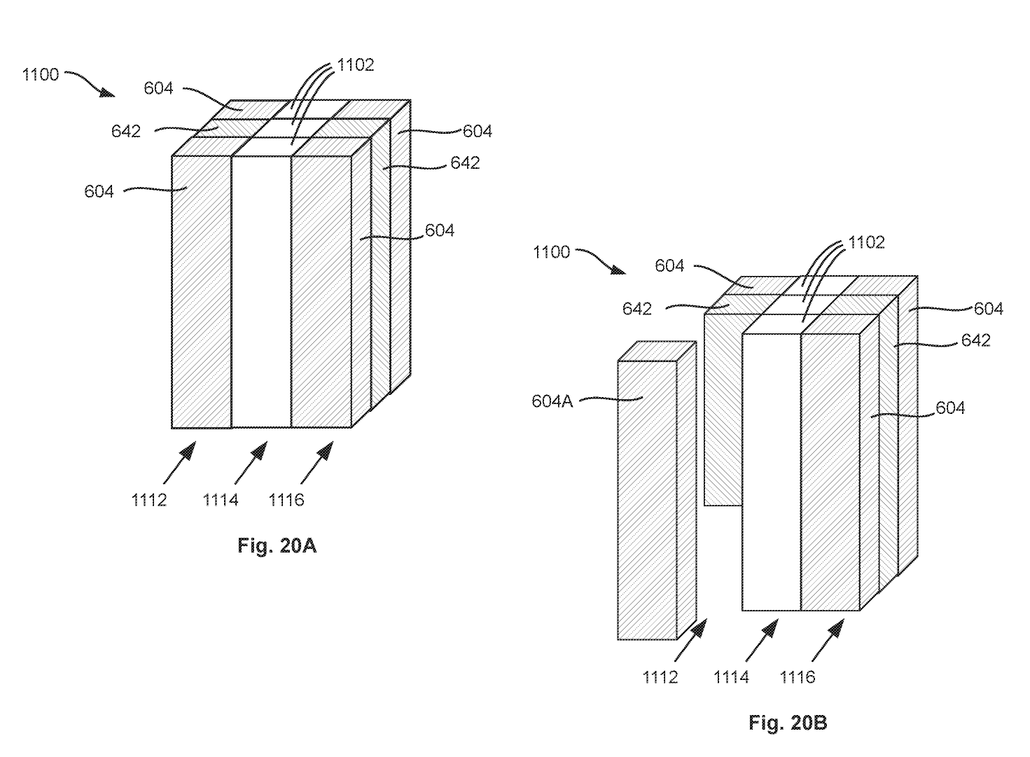

FIG. 20A shows an example of a modularized GIC evaporator block 1100 for configuring a GIC evaporator 700 or 740. The GIC evaporator block 1100 comprises nine (9) modules, including two (2) vapor drum modules 642, four (4) heating element modules 604, and three (3) piping modules 1102. As shown, the nine modules are arranged into three columns 1112, 1114 and 1116, each comprising three (3) rows. The middle column 1114 comprises three (3) piping modules 1102. Each of the columns 1112 and 1116 comprises two (2) heating element modules 604 and one (1) vapor drum module 642, with the vapor drum module 642 in the middle row thereof.

Therefore, the four (4) heating element modules 604 are located at the corners of the GIC evaporator block 1100, giving rise to minimum obstructions during possible replacement of the heating element modules 604.

For example, as shown in FIG. 20B, when a heating element module 604A is fouled and requires cleaning, the heating element module 604A can be isolated from the evaporator block 1100, and replaced with a clean one (not shown). The replaced module 604A is then sent offsite for cleaning. Shifting cleaning from onsite to offsite leads to considerable benefits, e.g., reduced down time and maintenance cost.

The replacement and transportation of the modules between the work site and the offsite cleaning/repairing place can be conducted by standard cranes, container handler and container trucks in a prompt and cost effective manner.

In above embodiments, the GIC evaporator 700 or 740 is an RFLTV evaporator. In some other embodiments, the GIC evaporator may be another type of evaporator with gas bubble injection. For example, in one embodiment, the GIC evaporator is a falling film evaporator with gas bubble injection.

Referring again to FIG. 10, in some embodiments wherein the temperature of the emulsion 104 is lower than the process temperature, the inlet heat exchanger 402 may heat up the emulsion 104 to the process temperature.

Referring again to FIGS. 9 and 10, in some embodiments, the water 114 discharged from the three-phase separator 144 and treater 146 only contains an ignorable amount of oil which would not affect the operation of the downstream high pressure steam generation 110. In this embodiment, the phase separation stage 106 does not comprise any de-oiling process/equipment.

Those skilled in the art appreciate that, in above embodiments, suitable piping manifolds, manual valves, control valves, flow meters and other instruments, electrical panels, and safety valves may be used as required.

Although embodiments have been described above with reference to the accompanying drawings, those of skill in the art will appreciate that variations and modifications may be made without departing from the scope thereof as defined by the appended claims.

What is claimed is:

1. A method of generating steam from an emulsion stream produced from a reservoir via thermal recovery, the emulsion stream being a mixture of oil and water, the method comprising:
adjusting the emulsion to a first temperature;
obtaining produced water from the emulsion at the first temperature; and
generating steam from the produced water at the first temperature.

2. The method of claim 1, wherein said first temperature is above 100° C.

3. The method of claim 1, wherein said obtaining produced water from the emulsion at the first temperature comprises:
separating water from the emulsion at the first temperature; and
removing residual oil from the separated water to obtain the produced water.

4. The method of claim 1, wherein said removing residual oil from the separated water to obtain the produced water comprises:
removing residual oil from the separated water by using at least two pressurized, high-temperature, induced gas flotation units (IGF's) coupled in series, to obtain the produced water.

5. The method of claim 4, wherein said generating steam from the produced water at the first temperature comprises:
generating steam from the produced water at the first temperature by using a high pressure evaporator operating at a first pressure.

6. The method of claim 5, wherein said removing residual oil from the separated water to obtain the produced water further comprises:
using at least one pump to adjust the pressure of the produced water to the first pressure, and to feed the produced water to the high pressure evaporator.

7. The method of claim 5, wherein said generating steam from the produced water at the first temperature by using the high pressure evaporator operating at the first pressure further comprises:
using solar power to directly heat up a heating medium of the high pressure evaporator;
feeding the produced water into the high pressure evaporator at the first temperature; and
generating steam from the produced water using the heated heating medium.

8. The method of claim 7, wherein said generating steam from the produced water at the first temperature by using the high pressure evaporator operating at the first pressure further comprises:
using a secondary heater as a secondary heating source for compensating for the solar power for heating up the heating medium of the high pressure evaporator.

9. The method of claim 5, wherein said generating steam from the produced water at the first temperature by using the high pressure evaporator operating at the first pressure further comprises:
separating impurities from the produced water, the separated impurities forming a blowdown stream;
cooling the blowdown stream; and
discharging the cooled blowdown stream.

10. The method of claim 5, wherein said generating steam from the produced water at the first temperature by using the high pressure evaporator operating at the first pressure further comprises:
injecting bubbles into the high pressure evaporator for fouling mitigation and heat transfer improvement.

11. A system for generating steam from a emulsion stream produced from a reservoir via thermal recovery, the emulsion stream being a mixture of oil and water, the system comprising:
a heat exchanger for adjusting the emulsion to a first temperature;
at least one separation device for separating water from the emulsion at the first temperature to obtain produced water; and
a high pressure evaporator for receiving the produced water at the first temperature and generating steam using the produced water.

12. The system of claim 11, wherein the high pressure evaporator comprises:
a vapor drum;
a heating element in fluid communication with the vapor drum, said heating element receiving the produced water at the first temperature;
a heating source for vaporizing the produced water for generating steam; and
a bubble generating device for generating bubbles and injecting generated bubbles into the heating element.

13. An evaporator receiving a water stream and generating steam from the water stream, the evaporator comprising:
a vapor drum;
a heating element in fluid communication with the vapor drum, said heating element receiving the water stream;
a heating source for vaporizing the water stream for generating steam; and
a bubble generator for generating bubbles and injecting generated bubbles into the heating element.

14. The evaporator of claim 13, wherein the bubble generator uses pipeline gas for generating bubbles.

15. The evaporator of claim 14, further comprising:
a condenser for receiving a portion of generated steam and condensing received steam to water; and wherein
the bubble generator receives the condensed water discharged from the condenser and mixes the pipeline gas with the received water for generating a water stream with gas bubbles for feeding into the heating element.

16. The evaporator of claim 13, wherein the bubble generator is a sparger.

17. The evaporator of claim 15, further comprising a steam/liquid interface separating steam thereabove and liquid therebelow; and wherein the steam/liquid interface is maintained at a level such that the one or more heating tubes are entirely submerged in liquid.

18. The evaporator of claim 13, wherein the evaporator is configured to a plurality of modules, the plurality of modules being interconnectable for forming a module block.

19. The evaporator of claim 18, wherein the plurality of modules comprise at least one vapor drum module, at least one heating element module and at least one piping module.

20. The evaporator of claim 19, wherein at least one heating element module is configured at a corner of a module block.
